(19) United States
(12) Patent Application Publication
(10) Pub. No.: US 2025/0314005 A1
(43) Pub. Date: Oct. 9, 2025

(54) LAUNDRY WASHING MACHINE HAVING A MICROPARTICLES FILTER DEVICE PROVIDED WITH A CLEANING DEVICE AND METHOD FOR REMOVING THE CLEANING DEVICE

(71) Applicant: ELECTROLUX APPLIANCES AKTIEBOLAG, Stockholm (SE)

(72) Inventors: Paolo CESCOT, Porcia (IT); Andrea CONTARINI, Porcia (IT); Marco MAIERO, Porcia (IT); Maurizio DEL POS, Porcia (IT); Carlo Antonio LEONE, Porcia (IT); Andrea ZATTIN, Porcia (IT); Marco PESSOT, Porcia (IT); Mattia RUSALEN, Porcia (IT); Stefano DE PAOLI, Porcia (IT)

(73) Assignee: ELECTROLUX APPLIANCES AKTIEBOLAG, Stockholm (SE)

(21) Appl. No.: 18/866,511

(22) PCT Filed: Jun. 9, 2022
(86) PCT No.: PCT/EP2022/065719

§ 371 Date: Nov. 15, 2024

(51) Int. Cl. D06F 39/10; B01D 41/04; D06F 39/08

(52) U.S. Cl. CPC D06F 39/10; B01D 41/04; D06F 39/083

(57) ABSTRACT

A laundry washing machine including a washing drum, a liquid supply system, a draining system and a microparticles filter device having a housing body, an inlet, and an outlet, a filtering chamber housed in the housing body, the filtering chamber having a microparticles filter element with a filtering surface on which microparticles accumulate while liquid flows therethrough. A cleaning device is movably arranged in the filtering chamber for removing microparticles that accumulate on the filtering surface, the cleaning device moving microparticles removed from the filtering surface towards a storage volume of a collecting chamber arranged at a side of the filtering chamber and in communication therewith. The collecting chamber is configured to be removably coupled with respect to the housing body and the cleaning device includes at least a portion extending into the storage volume of the collecting chamber thereby providing an extraction aid member to remove the cleaning device from the housing body when the collecting chamber is removed from the housing body.

### FIELD OF THE INVENTION

The present invention concerns the field of laundry washing techniques. Specifically, the invention relates to a laundry washing machine having a microparticles filter device provided with a cleaning device. The invention also relates a method for removing the cleaning device.

### BACKGROUND ART

Nowadays the use of laundry washing machines, both “simple” laundry washing machines (i.e. laundry washing machines which can only wash, rinse and spin laundry) and laundry washing-drying machines (i.e. laundry washing machines which can also dry laundry by means of a drying airflow), is widespread.

In the present description the term “laundry washing machine” will refer to a simple laundry washing machine or a laundry washing-drying machine.

As known, in laundry washing machine laundry to be washed is received in a rotatable washing drum contained in a washing tub.

It is known that during laundry washing cycles, laundry undergoes to mechanical and/or chemical treatments inside the washing drum with the use of a washing liquor, typically water with the possible addition of washing/rinsing products such as detergent, softener, rinse conditioner, etc.

Laundry to be treated in a laundry washing machine typically comprises clothes and linens made of natural or synthetic fabrics. During washing and/or rinsing treatments, laundry loses tiny particles, called microparticles or microfibers. In particular, clothes comprising synthetic materials lose tiny plastic particles fibres, called microplastics, which are non-biodegradable.

Microparticles/microplastics end up in the wastewater drained from the laundry washing machine and eventually end up in the environment contributing to environmental pollution. For example, microplastics washed off from laundry greatly contribute to plastic that is polluting seas and oceans.

Different solutions have been proposed in known laundry washing machines by arranging a microparticles filter to capture microparticles and reduce their drainage in the wastewater.

In a first type of known systems, the microparticles filter is placed outside the machine along the draining hose that is connected to a drainage.

In different embodiments of known systems, the microparticles filter is placed along a proper hydraulic line inside the machine.

A first known system for microparticles filtration used in a laundry washing machine is disclosed in WO2019081013A1. Here a microparticles filter is arranged along a re-circulation line that takes liquid from the bottom of the washing tub and conveys the same in an upper point of the same washing tub.

The microparticles filter comprises a filtering element, or filter membrane, arranged in a filtering chamber of the filter. According to some embodiments disclosed therein, a cleaning device is movably arranged in the filtering chamber for removing microparticles that accumulate on the filter membrane. Microparticles removed from the filter membrane by the cleaning device are pushed towards a microparticles collecting chamber arranged at a side of the filtering chamber and separated therefrom. Removed microparticles enter the microparticles collecting chamber through an opening closed by a controllable flap. The collecting chamber is then accessible from outside to a user via a door realized on the outer cabinet of the machine so that it can be removed manually. In known microparticles filters the filter membrane may be subject to a certain level of clogging over time despite the wiping action of the cleaning device.

An object of the present invention is therefore to provide a solution that allows maintenance of the filtering element, such as cleaning or replacing operations of the filtering element.

Another object of the present invention is to develop a filtering system in a laundry washing machine that assures easy accessibility to the filtering element during maintenance.

### DISCLOSURE OF INVENTION

Applicant has found that by providing a laundry washing machine comprising a microparticles filter device having a microparticles filter element having a filtering surface on which microparticles accumulate while the liquid flows therethrough and a cleaning device for removing microparticles accumulated on said filtering surface and moving the microparticles towards a collecting chamber and by providing the cleaning device with a portion extending into the collecting chamber it is possible to reach the mentioned objects.

In a first aspect thereof the present invention relates, therefore, to a laundry washing machine comprising:
an outer cabinet;
a washing tub containing a washing drum suited to receive the laundry to be washed;
a liquid supply system suitable to convey a liquid to said washing tub;
a draining system suitable to drain liquid outside said outer cabinet;
a microparticles filter device comprising:
a housing body;
an inlet for liquid to be filtered;
a filtering chamber housed in said housing body, said filtering chamber comprising a microparticles filter element having a filtering surface on which microparticles accumulate while said liquid flows therethrough;
an outlet for filtered liquid;
a cleaning device movably arranged in said filtering chamber for removing microparticles that accumulate on said filtering surface, said cleaning device moving microparticles removed from said filtering surface towards a storage volume of a collecting chamber arranged at a side of said filtering chamber and in communication therewith;
wherein said collecting chamber is configured to be removably coupled with respect to said housing body and wherein said cleaning device comprises at least a portion extending into said storage volume of said collecting chamber thereby providing an extraction aid member to remove said cleaning device from said housing body when said collecting chamber is removed from said housing body. Advantageously, the collecting chamber, when coupled with the housing body of the microparticles filter device, closes an opening, which is provided in said housing body, through which, or by means of which, an extraction aid member can be reached by a user to remove the cleaning device from the housing body. In one embodiment, the extraction aid member can be removed from the housing body by passing the cleaning device through said opening.

In a preferred embodiment, the collecting chamber is embodied as a cap for closing an opening provided in the housing body.

In a preferred embodiment, the portion of the cleaning device extending into the storage volume, provided in said collecting chamber to accumulate microparticles, occupies a volume portion of the storage volume ranging from 2% to 30%, or 25% or 20% or 15% or 10% or 8% or 5% of the overall storage volume. The volume portion occupied by the portion of the cleaning device extending into said storage volume is dimensioned according to the microparticles accumulation capacity that has to be assigned to the microparticles filter device, taking also into account the free space available within the outer cabinet of a laundry treating machine and the resulting size of the microparticles filter device. This has beneficial advantages on increasing the number of laundry treatments that the machine can perform without emptying the collecting chamber.

In an embodiment of the invention, the cleaning device extends into the storage volume of said collecting chamber, along an extension direction which is ranging from 15% to 100% of the storage volume extension along the same direction.

In an embodiment of the invention wherein the cleaning device extends into the storage volume of the collecting chamber along an extension direction which is lower than 100% of the storage volume extension along the same direction, the cleaning device has a cantilever end portion inside the storage volume, i.e. inside the collecting chamber.

Advantageously, when the collecting chamber is removed from the housing body the portion of the cleaning device extending into the collecting chamber may be used as an extraction aid member to remove the cleaning device. After removal of the cleaning device, the microparticles filter element is advantageously accessible for a proper cleaning process.

Preferably, the filtering chamber is formed by a portion of the housing body. Preferably, the majority of the microparticles filter device is arranged inside the outer cabinet of the laundry washing machine.

In a preferred embodiment, the microparticles filter element is removably arranged in the filtering chamber.

Advantageously, the microparticles filter element may be extracted out from the filtering chamber and from the housing body for a proper cleaning process or substitution, if necessary.

Further advantageously, the microparticles filter element may be extracted out from the filtering chamber and from the housing body through an opening provided in the housing body.

In one embodiment the same opening provided in the housing body allows the extraction of the cleaning device and the microparticles filter element from the housing body.

Preferably, the cleaning device is configured to be removably coupled to the filtering chamber.

Advantageously, the cleaning device may be easily extracted out from the filtering chamber so that the microparticles filter element and its filtering surface are advantageously accessible from outside. A user may hence advantageously reach the microparticles filter element and its filtering surface for a proper cleaning process.

According to a preferred embodiment of the invention, the cleaning device comprises a rotatable element apt to remove microparticles that accumulate on the filtering surface.

In a preferred embodiment, the rotatable element comprises a worm comprising a first end shaft body, a second end shaft body and a helix-shaped element connecting the end shaft bodies and winding around a main axis.

Preferably, the rotatable element further comprises a central shaft body extending along the main axis between the first and second end shaft bodies, wherein the helix-shaped element winds around the central shaft body.

Advantageously, the rotatable element wipes a side of the filtering surface of the microparticles filter element and moves microparticles towards the collecting chamber, acting as a worm conveyor.

According to a preferred embodiment of the invention, the helix-shaped element at least partially extends into the collecting chamber.

Advantageously, microparticles moved towards the collecting chamber are pressed therein maximizing the storage of microparticles inside the collecting chamber. In a further preferred embodiment, the cleaning device comprises a translatable element provided for wiping a side of the filtering surface, said translatable element preferably comprising a piston.

Preferably, an actuating device is provided for moving the cleaning device. According to a preferred embodiment of the invention, the actuating device comprises an electric motor.

In a preferred embodiment, the cleaning device and the collecting chamber are removably coupled one another, so that when the collecting chamber is removed from the housing body the collecting chamber is disconnected from the cleaning device.

In a further alternative preferred embodiment, the cleaning device and the collecting chamber are removably connected one another by means of a releasable locking device, so that they can be disconnected one from the other by releasing the releasable locking device after being unitarily removed from said housing body.

According to a preferred embodiment of the invention, the collecting chamber is screwable to the housing body.

Advantageously, the collecting chamber may be easily disconnected/connected from/to the housing body.

In a preferred embodiment, the microparticles filter element is a disposable filter element.

In a preferred embodiment, the microparticles filter device is arranged in a flow path between the liquid supply system and the draining system.

According to a preferred embodiment of the invention, the microparticles filter device is arranged in the draining system.

In a preferred embodiment, the draining system comprises a draining pump and an outlet pipe ending outside the outer cabinet, wherein the microparticles filter device is arranged in a portion of the outlet pipe contained within the volume defined by the outer cabinet.

In a further preferred embodiment, the microparticles filter device is arranged downstream a fluid outlet of the draining pump.

Advantageously, the liquid is subjected to a filtration process preventing microparticles leaving the laundry washing machine before the liquid reaches a drainage outside the machine.

In a preferred embodiment, the outer cabinet of the machine further comprises an aperture so that the collecting chamber of the microparticles filter device is accessible therefrom. Preferably, the outer cabinet further comprises an openable door associated to the aperture.

According to a preferred embodiment of the invention, the collecting chamber is arranged to close the aperture so that the collecting chamber is advantageously directly accessible to a user.

According to a further preferred embodiment of the invention, the microparticles filter device is mounted to an outer side of a wall of the outer cabinet and the inlet of the microparticles filter device is connected to the draining system by means of an outlet pipe ending outside the outer cabinet of the laundry washing machine. Preferably, the microparticles filter device is mounted to an outer side of a wall of the outer cabinet by means of a connecting device.

According to this embodiment, advantageously, an existing laundry washing machine may be equipped with a microparticles filter device preventing microparticles leaving the laundry washing machine.

Preferably, the microparticles filter device is a filter suitable to retain particles having a minimum dimension comprised between 0,1 μm and 5 mm, preferably a minimum dimension comprised between 10 μm and 100 μm, more preferably a minimum dimension comprised between 10 μm and 75 μm.

Advantageously, the microparticles filter device is suitable to retain particles present in the waste liquid produced by mechanical and/or chemical treatments of the laundry inside the washing drum, preferably tiny plastic particles released by the laundry, also indicated as microplastics, which are non-biodegradable.

According to a preferred embodiment of the invention, the laundry washing machine further comprises an objects filter device arranged upstream the microparticles filter device for stopping objects having a maximum dimension higher than 5 mm contained in the liquid to be filtered when the liquid flows therethrough.

In a preferred embodiment, the objects filter device is housed in the housing body, wherein the objects filter device and the microparticles filter device define a filtering group assembly, wherein the objects filter device is provided in a position opposite to the collecting chamber and located between an inlet of the filtering group assembly and the microparticles filter device, said objects filter device comprising a second filtering chamber receiving a portion of the cleaning device therein.

Preferably, the liquid supply system includes at least one recirculation system for draining liquid from a bottom region of the washing tub to a second region of the washing tub.

According to a preferred embodiment of the invention, the liquid supply system comprises a water supply system suited to be connected to an external water supply line, preferably comprising a controlled supply valve.

In a preferred embodiment, the liquid supply system further comprises a treating agents dispenser suited to receive one or more treating agents, wherein water is supplied into the washing tub from the external water supply line by making it flow through the treating agents dispenser so that water and one or more treating agents may be supplied into the washing tub.

In a further aspect thereof, the present invention relates to a method for removing a cleaning device of a microparticles filter device in a laundry washing machine realized as described above, wherein the method comprises the steps of:
removing said collecting chamber from said housing body;
removing said cleaning device from said housing body by means of said extraction aid member.

In a preferred embodiment, the step of removing the cleaning device from the housing body by means of the extraction aid member is performed after the step of removing the collecting chamber from the housing body wherein, after the collecting chamber has been removed, the extraction aid member is accessible to a user.

In a further preferred alternative embodiment, the step of removing the collecting chamber from the housing body and the step of removing the cleaning device from the housing body are performed simultaneously, wherein the collecting chamber and the extraction aid member remain engaged while the collecting chamber is removed from the housing body. In this case, preferably, the method further comprises a step of disengaging the extraction aid member from the collecting chamber after the extraction aid member and the collecting chamber have been simultaneously removed from the housing body.

### BRIEF DESCRIPTION OF THE DRAWINGS

Further characteristics and advantages of the present invention will be highlighted in greater detail in the following detailed description of some of its preferred embodiments, provided with reference to the enclosed drawings. In the drawings, corresponding characteristics and/or components are identified by the same reference numbers. In particular:

FIG. 1 shows a frontal view of a laundry washing machine according to a first embodiment of the invention;

FIG. 2 shows a schematic view of the laundry washing machine of FIG. 1;

FIG. 3 shows a lateral view of the laundry washing machine of FIG. 1 with an external side wall removed therefrom;

FIG. 4 shows the microparticles filter device of the laundry washing machine of FIG. 3 isolated from the rest;

FIG. 5 is a longitudinal sectional view of the microparticles filter device of FIG. 4;

FIG. 6 shows the microparticles filter device of FIG. 5 in a first operating position;

FIG. 7 shows an exploded view of the microparticles filter device of FIG. 5;

FIG. 8 shows a longitudinal sectional view of a further embodiment of the microparticles filter device of the invention in a first operating position;

FIG. 9 shows an enlarged detail of FIG. 8;

FIG. 10 shows a further embodiment of an element of the microparticles filter device according to the invention;

FIG. 11 shows a further embodiment of FIG. 5 according to a further embodiment of the microparticles filter device of the invention;

FIG. 12 shows a schematic view of the laundry washing machine of the invention according to a further embodiment of the invention;

FIGS. 13A and 13B show a frontal view of the laundry washing machine according to the schematic view of FIG. 12;

FIG. 13C shows a further embodiment of FIG. 13B;

FIGS. 14 and 15 show schematic views of the laundry washing machine of the invention according to further embodiments of the invention;

FIG. 16 shows a further embodiment of FIG. 5 according to a further embodiment of the microparticles filter device of the invention;

FIGS. 17 shows a schematic view of the laundry washing machine of the invention according to a further embodiment of the invention.

### DETAILED DESCRIPTION OF PREFERRED EMBODIMENTS OF THE INVENTION

As described below, the present invention has proved to be particularly advantageous when applied to laundry washing machines, i.e. appliances able to carry out at least a washing process on laundry and optionally further able to perform a drying process on laundry. In this view the present invention can be applied to laundry washing and drying machines.

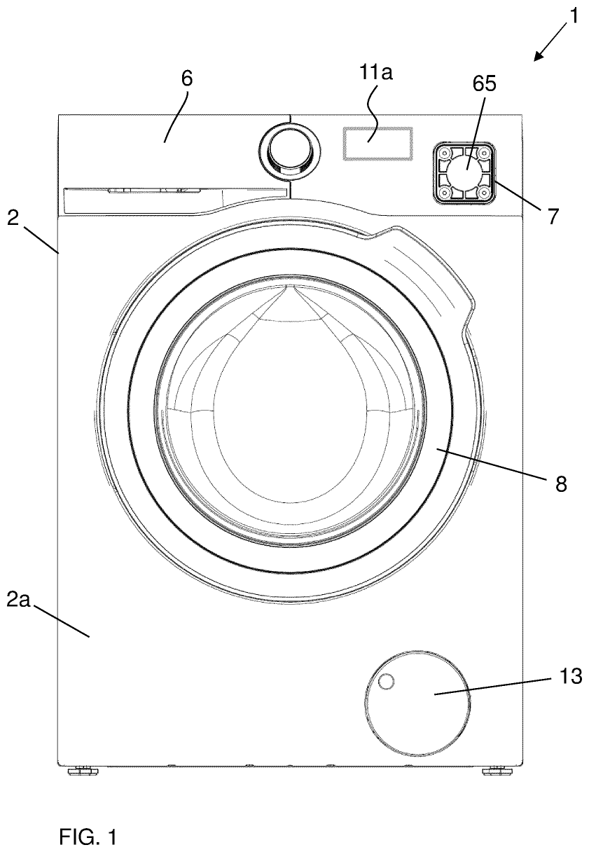

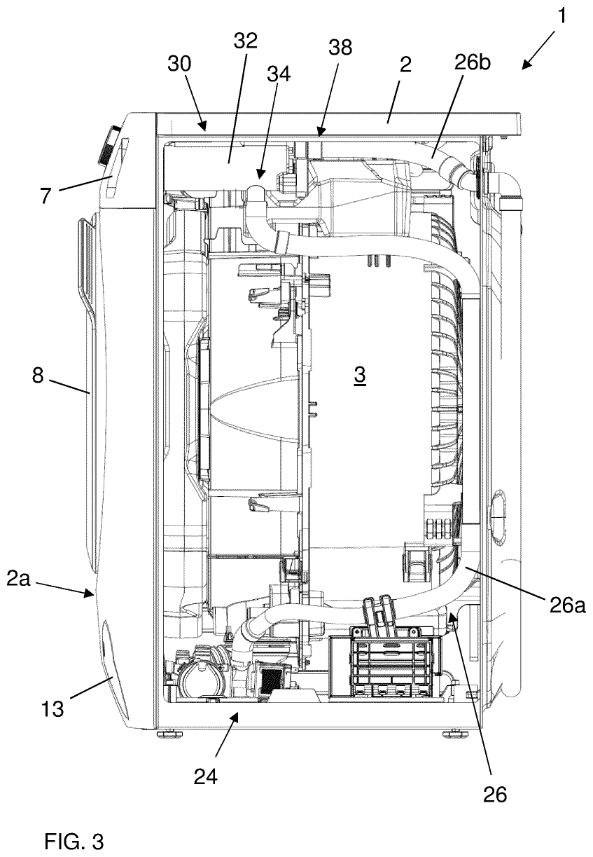

With reference to FIGS. 1 to 3, a preferred embodiment of a laundry washing machine 1 according to the invention is described.

The laundry washing machine 1 preferably comprises an external casing or outer cabinet 2, a washing tub 3, a container 4, preferably a perforated washing drum 4, where the laundry to be treated can be loaded.

The washing tub 3 and the washing drum 4 both preferably have a substantially cylindrical shape.

The cabinet 2 at its front side wall 2a is provided with a loading/unloading door 8 which allows access to the washing drum 4.

The washing drum 4 is advantageously rotated by an electric motor, as known in the art, which preferably transmits the rotating motion to the shaft of the washing drum 4, advantageously by means of a belt/pulley system. In a different embodiment of the invention, the motor can be directly associated with the shaft of the washing drum 4.

The washing drum 4 is advantageously provided with holes or apertures which allow the liquid flowing therethrough. Said holes are typically and preferably homogeneously distributed on the cylindrical side wall of the washing drum 4. The bottom region 3a of the washing tub 3 preferably comprises a seat 15, or sump, suitable for receiving a heating device 10. The heating device 10, when activated, heats the liquid collected inside the sump 15.

In further embodiments, other type of heating device may be advantageously placed in the machine 1 to heat liquid.

Preferably, the laundry washing machine 1 comprises a device 19 suited to sense (or detect) the liquid level inside the washing tub 3.

The sensor device 19 preferably comprises a pressure sensor which senses the pressure in a chamber formed in, or connected to, the washing tub 3. Such chamber can be partially filled by the liquid contained in the washing tub 3, thereby modifying the pressure in the unfilled portion of said chamber. From the pressure values sensed by the sensor device 19 it is possible to determine the liquid level of the liquid inside the washing tub 3. In another embodiment, not illustrated, laundry washing machine may preferably comprise (in addition to or as a replacement of the pressure sensor) a level sensor (for example mechanical, electro-mechanical, optical, etc.) adapted to sense (or detect) the liquid level inside the washing tub 3. A liquid (water) supply system 5 is preferably arranged in the upper part of the laundry washing machine 1 and is suited to supply water into the washing tub 3 from an external water supply line E. The water supply system 5 preferably comprises a controlled supply valve 5a which is properly controlled, opened and closed, during a washing cycle to properly carry out all the phases thereof. The water supply system of a laundry washing machine is well known in the art, and therefore it will not be described in detail.

Liquid supply system refers, in general, to any system apt to supply water or any liquid into the tub.

The laundry washing machine 1 advantageously comprises a treating agents dispenser 14 to supply one or more treating agents into the washing tub 3 during a washing cycle. Treating agents may comprise, for example, detergents, rinse additives, fabric softeners or fabric conditioners, waterproofing agents, fabric enhancers, rinse sanitization additives, chlorine-based additives, etc.

Preferably, the treating agents dispenser 14 comprises a removable drawer 6 provided with various compartments suited to be filled with the treating agents. In the preferred embodiment here illustrated, the water is supplied into the washing tub 3 from the water supply system 5 by making it flow through the treating agents dispenser 14 and then through a supply pipe 18. The provision of the treating agents to the washing tub 3 may be performed by automatically dosing an amount of said agents before delivering them to the washing tub 3. Such dosage is preferably performed by a dosing device having metering means for measuring a desired amount of an agent to be taken from a treating agent storage and delivered to the washing tub 3.

In an alternative embodiment of the invention, a further separate water supply pipe can be provided, which supplies exclusively clean water into the washing tub from the external water supply line.

In further preferred embodiments, not illustrated herein, a water softening device may preferably be arranged/interposed between the external water supply line and the treating agents dispenser so as to be crossed by the fresh water flowing from the external water supply line. The water softening device, as known, is structured for reducing the hardness degree of the fresh water drawn from the external water supply line and conveyed to the treating agents dispenser.

In a different embodiment, the water softening device may be arranged/interposed between the external water supply line and the washing tub, so as to be crossed by the fresh water flowing from the external water supply line and conveying it directly to the washing tub.

Laundry washing machine 1 preferably comprises a draining system 20 to drain liquid outside the cabinet 2 up to a drainage (not shown). More preferably the draining system 20 withdraws liquid from the bottom region 3a of the washing tub 3 and drains it outside the cabinet 2.

The draining system 20 preferably comprises a main pipe 22, a draining pump 24 and an outlet pipe 26 ending outside the cabinet 2.

Preferably, the draining pump 24 is a centrifugal pump provided with a rotating component, or impeller, that moves the liquid to a pump fluid outlet 24a.

The draining system 20 preferably further comprises an objects filter device 28 arranged between the main pipe 22 and the draining pump 24.

The objects filter device 28 is adapted to stop objects before they reach the draining pump 24. The objects filter device 28 has the aim of retain undesirable objects that may damage the draining pump 24, for example may damage the impeller in case a centrifugal pump design is used.

Said kind of objects, also indicated hereinafter as coarse material, may comprise, for example, buttons, coins, screws, needles, paper clips, pieces of clothes, etc. Preferably, the objects filter device 28 is suitable to filter objects having a maximum dimension higher than 5 mm.

In a preferred embodiment, the objects filter device preferably comprises a casing having a housing wherein a objects filter element is received. The housing preferably forms a channel through which liquid to be filtered flows. Said objects filter element is preferably provided with a meandering structure, for example in the form of tabs that are arranged along the channel when the objects filter element is placed within the housing so as to create a labyrinthic path through which the liquid flows while objects are stopped by the tabs.

For cleaning purposes, the objects filter device 28 can preferably be removed from the housing and from the cabinet 2 through an openable gate 13 placed advantageously on the front side wall 2a of the cabinet 2, as illustrated in FIG. 1.

The objects filter device 28 and respective gate 13 are arranged in the lower part of the laundry washing machine 1, more preferably in the lower right side of the laundry washing machine 1.

The draining pump 24 and the objects filter device 28 are preferably embodied as a group assembly, for example by directly connecting the draining pump 24 to the casing defining the housing of the objects filter device 28.

The main pipe 22 preferably connects the bottom region 3a of the washing tub 3 to the objects filter device 28.

In a further embodiment, not illustrated, the casing of the objects filter device may be provided directly in the washing tub, preferably obtained in a single piece construction with the latter. In this case, the objects filter device is fluidly connected to the outlet of the washing tub, in such a way that liquid drained from the washing tub enters the objects filter device.

Activation of the draining pump 24 drains the liquid, i.e. water or water mixed with washing and/or rinsing products, from the washing tub 3 to the outside.

Laundry washing machine 1 advantageously comprises a control unit 11 which is in signal and/or electrical communication to the various operational parts of the laundry washing machine 1 such as drum motor, sensors, etc., in order to ensure its operation for carrying out a laundry treating program. The control unit 11 is advantageously connected also to an interface unit 11a which is accessible to the user and by means of which the user selects and sets the washing parameters from time to time, in particular a desired laundry washing or treating program.

According to an aspect of the invention, the laundry washing machine 1 comprises a microparticles filter device 30. According to the preferred embodiment shown in FIGS. 1 to 7, the microparticles filter device 30 is preferably arranged within the cabinet 2, in a flow path between the water supply system 5 and the draining system 20. Preferably, the microparticles filter device 30 is arranged in the draining system 20, preferably along the outlet pipe 26 of the draining system 20, more preferably in a portion of said outlet pipe 26 contained within the volume defined by the cabinet 2.

The microparticles filter device 30 is then preferably arranged downstream the fluid outlet 24a of the draining pump 24.

Before the liquid reaches a drainage outside the machine 1, liquid is therefore subjected to a filtration process preventing microparticles leaving the laundry washing machine 1.

The microparticles filter device 30 is configured to retain particles having a minimum dimension comprised between 0,1 μm and 5 mm, preferably a minimum dimension comprised between 10 μm and 100 μm, more preferably a minimum dimension comprised between 10 μm and 75 μm.

Particles of this type are typically present in the waste liquid produced by mechanical and/or chemical treatments of the laundry inside the washing drum 4 as tiny particles are released by the laundry. In particular, laundry comprising synthetic materials loses tiny plastic particles fibres, also indicated as microplastics, which are non-biodegradable.

The microparticles filter device 30, therefore, advantageously acts as a microplastics filter device 30.

The microparticles filter device 30 is preferably arranged downstream the objects filter device 28 or, in other words, the objects filter device 28 is preferably arranged upstream the microparticles filter device 30 to advantageously prevent coarse material to reach the microparticles filter device 30 causing a potential damage thereto.

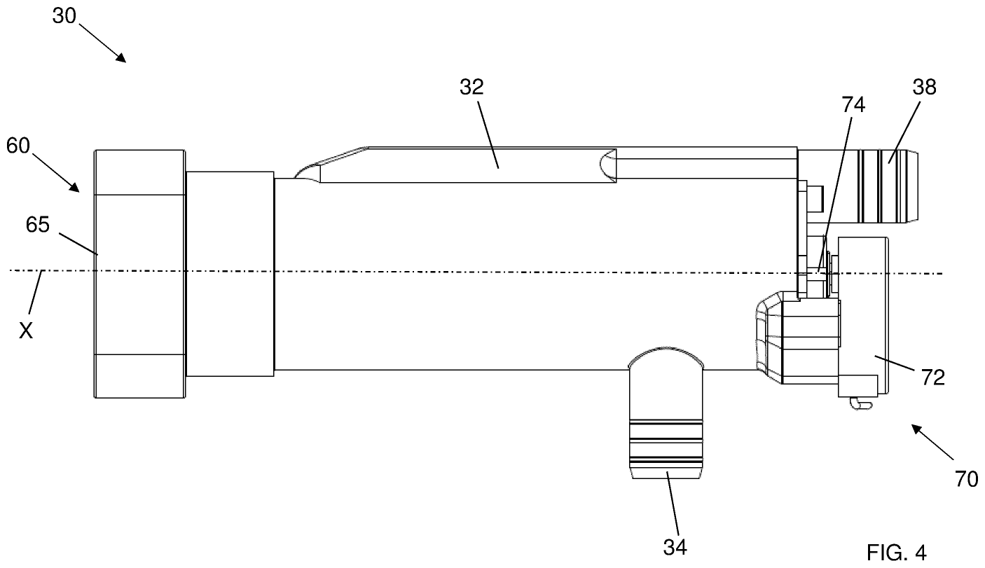

The microparticles filter device 30 is better described in detail with reference to FIGS. 4 to 7.

The microparticles filter device 30 preferably shows an elongated shape and preferably extends along a main axis X.

The microparticles filter device 30 comprises a housing body 32, preferably made of a plastic, i.e. polymeric, material.

According to the preferred embodiment illustrated in the FIGS. 1-7, the microparticles filter device 30 is preferably arranged in the upper part of the laundry washing machine 1, more preferably in the upper right side of the laundry washing machine 1. Positioning of the microparticles filter device 30 in the upper position enhances the user interaction with the same microparticles filter device 30.

The microparticles filter device 30 is preferably vertically aligned to the draining pump 24 to keep the pipe length connecting the draining pump 24 with the microparticles filter device 30 as short as possible to reduce the pump 24 strength. The microparticles filter device 30 comprises an inlet 34 for liquid to be filtered, a filtering chamber 36 and an outlet 38 for filtered liquid.

The inlet 34 of the microparticles filter device 30 is connected to a first portion 26a of the outlet pipe 26 and the outlet 38 of the microparticles filter device 30 is connected to a second portion 26b of the outlet pipe 26 which preferably protrudes out of the cabinet 2, preferably from a rear side wall of the cabinet 2.

The second portion 26b of the outlet pipe 26 preferably comprises an end connector on an outer surface, preferably the rear wall, of the cabinet 2 to hydraulically connect the laundry washing machine 1 to a drainage outside the machine 1.

The first portion 26a of the outlet pipe 26 fluidically connects the draining pump 24 and the microparticles filter device 30.

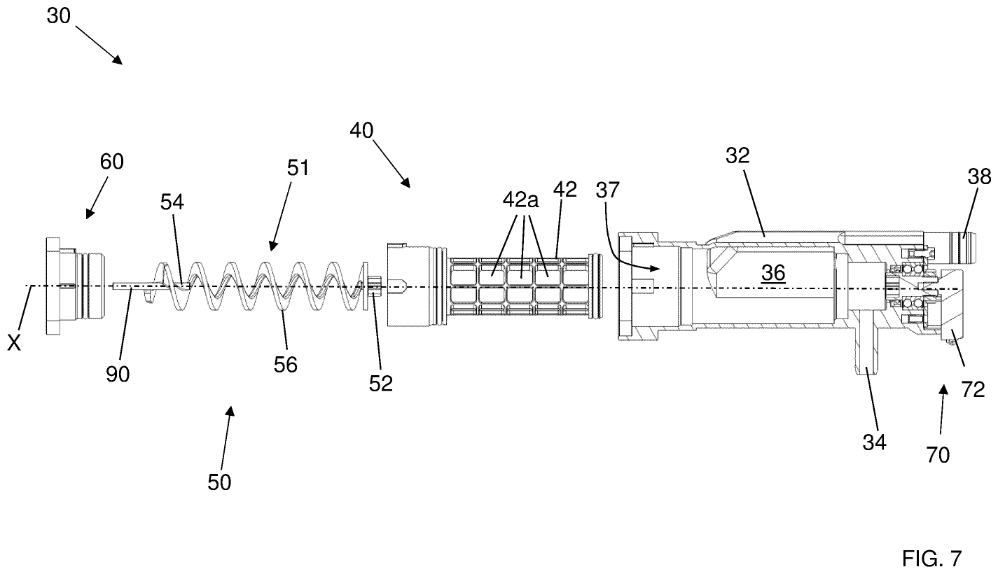

The filtering chamber 36, better visible in FIG. 7, receives therein a microparticles filter element 40 having a filtering surface 42 at which microparticles accumulate while the liquid flows therethrough.

An amount of the volume encased by the housing body 32 defines the filtering chamber 36.

The filtering chamber 36 is thus housed in the housing body 32.

The filtering chamber 36 is preferably cylindrically shaped and the microparticles filter element 40 preferably has a cylindrical tubular shape. The filtering chamber 36 and the microparticles filter element 40 preferably extends along said main axis X. The filtering surface 42 preferably comprises a plurality of meshes 42a, more preferably rectangular meshes 42a (as visible in FIG. 7).

Meshes 42a are preferably realized with a woven wire. In a preferred embodiment the wire is made of polyethylene. Said plurality of meshes 42a can be provided by one or more layers of woven wire covering a plurality of openings formed in a body portion of the microparticles filter element 40.

Preferably, the mesh is chosen to have a mesh size configured to retain particles having a minimum dimension comprised between 0,1 μm and 5 mm, preferably a minimum dimension comprised between 10 μm and 100 μm, more preferably a minimum dimension comprised between 10 μm and 75 μm, as said above.

The microparticles filter element 40 preferably defines an unfiltered volume 43 apt to receive the liquid before its filtration and coming from the inlet 34. According to the preferred embodiment here illustrated, the unfiltered volume 43 corresponds to the inner cylindrical volume of the microparticles filter element 40. In a normal operating condition of the microparticles filter device 30, the liquid is supplied into the unfiltered volume 43 from the inlet 34 and then undergoes to filtration by passing through the microparticles filter element 40, in particular by passing through meshes 42a. The filtered liquid thus reaches an elongated annular chamber 44 that is radially outer the microparticles filter element 40 and that forms part of the filtering chamber 36. The elongated annular chamber 44 hydraulically communicates with the outlet 38 of the microparticles filter device 30.

While the liquid flows through the microparticles filter element 40, microparticles progressively accumulate on the filtering surface 42.

The extension of the filtering chamber 36 along the main axis X substantially corresponds to the filtering area defined by microparticles filter element 40 and, more preferably, defined by said meshes 42a.

Nevertheless, the filtering chamber 36 may comprise portions that extends outside said filtering area and that are preferably used to assemble the microparticles filter element, for example for receiving sealing elements as described later, or for the connection of the microparticles filter element to other parts of the microparticles filter device.

The microparticles filter device 30 is equipped with a cleaning device 50 which is configured to remove microparticles that accumulate on the first side of the filtering surface 42 of the filtering element 40 that the liquid encounters when passing through said filtering surface 42.

The cleaning device 50 is preferably arranged inside the microparticles filter element 40 for moving microparticles it removes from the filtering surface 42 towards a storage volume 61 of a collecting chamber 60. The collecting chamber 60 is arranged at a side, in particular an end side, of the filtering chamber 36 and in communication therewith.

According to the preferred embodiment described herein, the movable cleaning device 50 comprises a rotatable element 51 wiping a side of the filtering surface 42, preferably wiping the first side of the filtering surface 42 that the liquid encounters and where microparticles accumulates. More preferably, the rotatable element 51 may be embodied as a worm having a first end shaft body 52, a second end shaft body 54 and a helix-shaped element 56 connecting the end shaft bodies 52, 54 and winding around a main axis X.

This main axis X corresponds to the direction through which the rotatable element 51 extends. In the preferred embodiment described herein, this main axis X preferably coincides with the main axis X of the microparticles filter device 30. The helix-shaped element 56 is preferably a circular helix-shaped element 56. The central part of the rotatable element 51, embodied as a worm, between the end shaft bodies 52, 54 and enclosed by the helix-shaped element 56 is therefore void and therefore the rotatable element 51 is embodied as a hollow worm.

In the embodiment described above, the rotatable element 51 is rotated around the main axis X, the helix-shaped element 56 wipes a side of the filtering surface 42 of the microparticles filter element 40 thereby removing microparticles accumulated thereon, and, at the same time, it is able to move microparticles towards the storage volume 61 of the collecting chamber 60, acting as a worm conveyor.

Microparticles are therefore collected into the storage volume 61 of the collecting chamber 60 as the rotatable element 51 rotates. Microparticles removed from the filtering surface 42 are conveyed towards the storage volume 61 of the collecting chamber 60 and towards an opening 37 provided in the housing body 32, such that microparticles can be removed from the microparticles filter device 30 by removing the collecting chamber 60 therefrom.

Preferably, the helix-shaped element 56 of the rotatable element 51 has its terminal part 56a that at least partially extends into the storage volume 61 of the collecting chamber 60.

Advantageously, microparticles moved towards the collecting chamber 60 are pressed in the storage volume 61 by the action of the terminal part 56a of the rotatable element 51. Microparticles are preferably squeezed inside the storage volume 61 with removal of the surplus of liquid contained therein that flow back to the filtering chamber 36. This maximizes the storage of microparticles inside the storage volume 61 and provides for an easy removal of a dried, packed microparticles mass.

Rotation of the rotatable element 51 is preferably obtained through an actuating device 70.

The actuating device 70 is preferably arranged at said first end shaft body 52 of the rotatable element 51 and preferably comprises an electric motor 72 having a rotatable shaft 74 cooperating with the first end shaft body 52 of the rotatable element 51.

An interconnection device 76 is preferably arranged between the first end shaft body 52 of the rotatable element 51 and the rotatable shaft 74 of the electric motor 72. The interconnection device 76 allows transmission of rotation of the rotatable shaft 74 to the rotatable element 51 and also allows disconnection of the rotatable element 51 from the rotatable shaft 74 so that the rotatable element 51 may be removed from the filtering chamber 36, as better described later.

Preferably, the interconnection device 76 comprises a joint element 78 rotatably mounted on the housing body 32 of the microparticles filter device 30 through a ball round bearing 80. The joint element 78 comprises a first end 82 connected to the shaft 74 of the motor 72 and a second end with a seat 84 receiving the first end shaft body 52 of the rotatable element 51. The seat 84 and the first end shaft body 52 of the rotatable element 51 are complementarily shaped, for example a cylindrical shape with a flat portion is used, so that they can rotate together when the rotatable element 51 works/rotates and they can be disconnected when the rotatable element 51 stops, preferably by extracting the rotatable element 51 from the seat 84 when the rotatable element 51 is pulled along the main axis X direction. According to an aspect of the invention, the collecting chamber 60 is configured to be removably coupled with respect to the housing body 32. The collecting chamber 60 works as a cap for the opening 37, closing the latter when it is coupled to the housing body 32.

According to a preferred embodiment illustrated in FIGS. 4-7, the collecting chamber 60 is preferably screwable to the housing body 32. A male thread 62 of the collecting chamber 60 preferably engages with a female thread 64 on the housing body 32 of the microparticles filter device 30.

Preferably, the collecting chamber 60 is screwable in a first direction to the housing body 32, preferably the clockwise direction, and the rotatable element 51 is also operated/rotated in the same first direction. Advantageously, when the rotatable element 51 is operated/rotated the risk of disconnecting, for example unscrewing, the collecting chamber 60 from the housing body 32 is prevented.

In further preferred embodiments, the collecting chamber may be configured to be removably coupled to the housing body 32 by a pushing or snap-in action.

According to a further aspect of the invention, the cleaning device 50 comprises a portion 90 extending into the storage volume 61 of the collecting chamber 60 thereby providing an extraction aid member 90 to remove the cleaning device 50 from the housing body 32 when the collecting chamber 60 is removed from the housing body 32, as better described later.

According to the preferred embodiment illustrated in FIGS. 4-7, the portion 90 of the cleaning device 50 extending into the storage volume 61 of the collecting chamber 60 is preferably embodied as a portion 90 that protrudes from the filtering chamber 36 and extends into the storage volume 61 of the collecting chamber 60. In this embodiment, the cleaning device 50 extends into the storage volume 61 of the collecting chamber 60 along the axis X for the entire storage volume 61 extension along the same axis X. The volume occupied by the cleaning device portion 90 extending inside the storage volume 61 is about 5% of the storage volume where microparticles are accumulated. In different embodiments, not shown in the drawings, the cleaning device 50 may extend into the storage volume 61 along a direction, for example the axis X in the FIGS. 4-7, for only a part of the storage volume extension along the same direction. The cleaning device may thus have a cantilever end portion.

Preferably, the portion 90 comprises an elongated pin at the second end shaft body 54 of the rotatable element 51. The elongated pin 90 is preferably integrally realized with the rotatable element 51.

The elongated pin 90 and the collecting chamber 60 are preferably removably coupled one another. The elongated pin 90 is preferably received in a supporting seat 63 realized in the storage volume 61 of the collecting chamber 60.

When the rotatable element 51 rotates, the elongated pin 90 rotates within the supporting seat 63. The supporting seat 63 preferably acts as a centering means while the rotatable element 51 works/rotates.

The supporting seat 63 and the elongated pin 90 are shaped, for example both cylindrically shaped, so that the elongated pin 90 may rotate with respect to the supporting seat 63 when the rotatable element 51 rotates while the collecting chamber 60 may be disengaged from the elongated pin 90 when the collecting chamber 60 is removed (for example, unscrewed) from the housing body 32.

The cleaning device 50 and the collecting chamber 60 are therefore preferably removably coupled one another so that the collecting chamber 60 can be disconnected from the cleaning device 50 when the collecting chamber 60 is removed from the housing body 32.

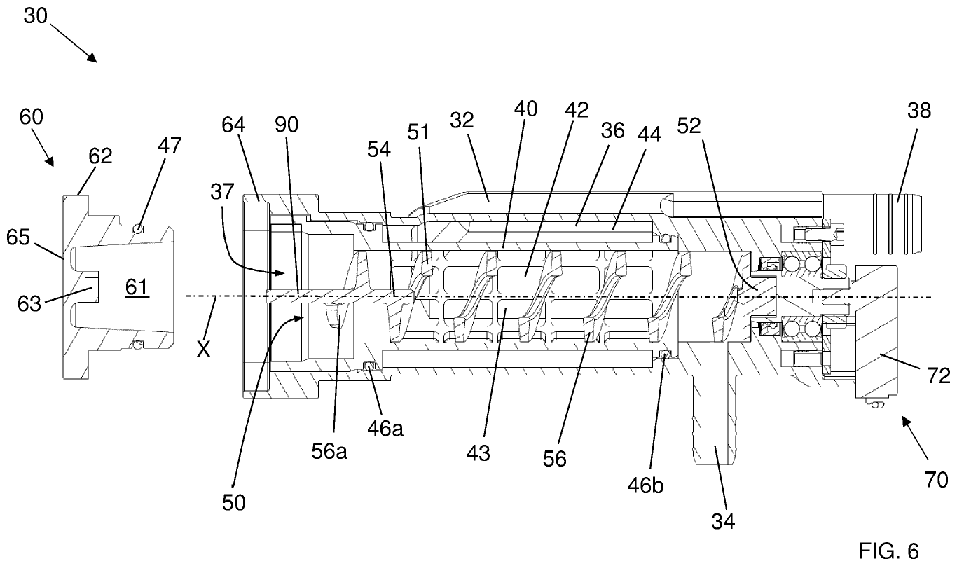

When the collecting chamber 60 is removed (for example, unscrewed) from the housing body 32, as illustrated in FIG. 6, the elongated pin 90 provides an extraction aid member 90 to remove the rotatable element 51 from the housing body 32. The rotatable element 51 is hence also advantageously removable from the filtering chamber 36. In particular, the rotatable element 51 can be removed from the filtering chamber 36 by extracting the rotatable element 51 through the opening 37 of the housing body 32.

The elongated pin 90, in fact, can be usefully grasped by a user and pulled along the main axis X so that the rotatable element 51 disconnects from the joint element 78 and can be fully extracted out of the housing body 32.

Operating position as illustrated in FIG. 6 preferably refers to a maintenance phase of the laundry washing machine 1 when the collecting chamber 60 needs to be removed and then cleaned from microparticles stored in the storage volume 61. As said above, from this operating position the rotatable element 51 may be fully extracted out of the housing body 32 by means of the extraction aid member 90 constituted by the elongated pin 90.

After the rotatable element 51 is fully extracted out of the housing body 32, the microparticles filter element 40 and its filtering surface 42 are advantageously accessible from outside. A user may reach the microparticles filter element 40 and its filtering surface 42 for a proper cleaning process that might be due after a relatively long operation time of the rotatable element 51 wiping a side of the filtering surface 42.

More preferably, the microparticles filter element 40 is removably arranged in the filtering chamber 36. Advantageously, after removal of the collecting chamber 60 the user may also extract the microparticles filter element 40 from the filtering chamber 36 and hence facilitating the cleaning process and/or substitution of the same in case the microparticles filter element 40 is worn out or damaged, as illustrated for example in the operating position of FIG. 7. In particular, the microparticles filter element 40 can be extracted from the filtering chamber 36 through the opening 37 of the housing body 32.

According to a preferred embodiment illustrated in the FIGS. 4-7, the microparticles filter element 40 is preferably removably received in the housing body 32 of the microparticles filter device 30 and may be preferably inserted and extracted along the main axis X, in particular through the opening 37 of the housing body 32. Therefore, the microparticles filter element 40 may be embodied as a disposable filter element that can be substituted, whenever it is necessary.

Between the microparticles filter element 40 and the housing body 32, sealing elements 46a, 46b, for example plastic, i.e. polymeric, O-rings, are preferably arranged to guarantee watertightness of the filtering chamber 36 during the filtering process.

The microparticles filter element 40 preferably extends towards the frontal part of the housing body 32 of the microparticles filter device 30 and preferably receives a portion of the collecting chamber 60 therein.

This facilitates extraction of the microparticles filter element 40 which may be grasped by the user after removal of the collecting chamber 60.

Preferably, a sealing element 47, for example plastic, i.e. polymeric, O-rings, is preferably arranged between the microparticles filter element 40 and the collecting chamber 60 to guarantee watertightness of the filtering chamber 36 during the filtering process.

As said above, the collecting chamber 60 is configured to be removably coupled with respect to the housing body 32 and in the preferred embodiment illustrated in FIGS. 4-7 the collecting chamber 60 is directly connectable, for example screwable, to the housing body 32 through male and female threads 62, 64. In further preferred embodiments, not illustrated, the collecting chamber may be removably coupled with respect to the housing body not directly coupling the collecting chamber to the housing body. For example, the collecting chamber may be removably coupled, e.g. screwable, to the frontal part of the microparticles filter element instead of to the housing body.

In a preferred embodiment illustrated herein, the cabinet 2 comprises an aperture 7, as shown in FIG. 1, so that the collecting chamber 60 of the microparticles filter device 30 is accessible to a user, from outside the cabinet 2.

The aperture 7 is preferably realized in the upper right side of the front side wall 2a of the laundry washing machine 1 and aligned with the microparticles filter device 30.

The collecting chamber 60 is preferably arranged to close the aperture 7 of the cabinet 2 so that said collecting chamber 60 is directly accessible to the user from a part of the cabinet remaining exposed to a user interaction.

More preferably, the microparticles filter device 30 is arranged with respect to said aperture 7 of the cabinet 2 so that the exposed surface 65 of the collecting chamber 60 fits preferably flush with the front side wall 2a of the cabinet 2 of the laundry washing machine 1.

The majority of the microparticles filter device 30 is thus preferably arranged inside the cabinet 2. Parts of the collecting chamber 60 accessible to the user, for example said exposed surface 65 flushing with the front side wall 2a of the cabinet 2, may not be arranged inside the cabinet 2.

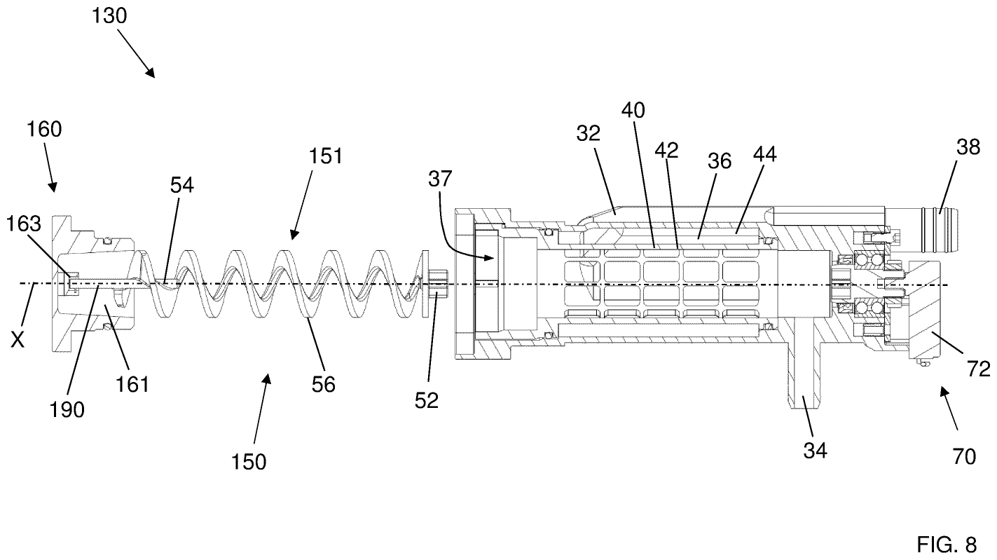

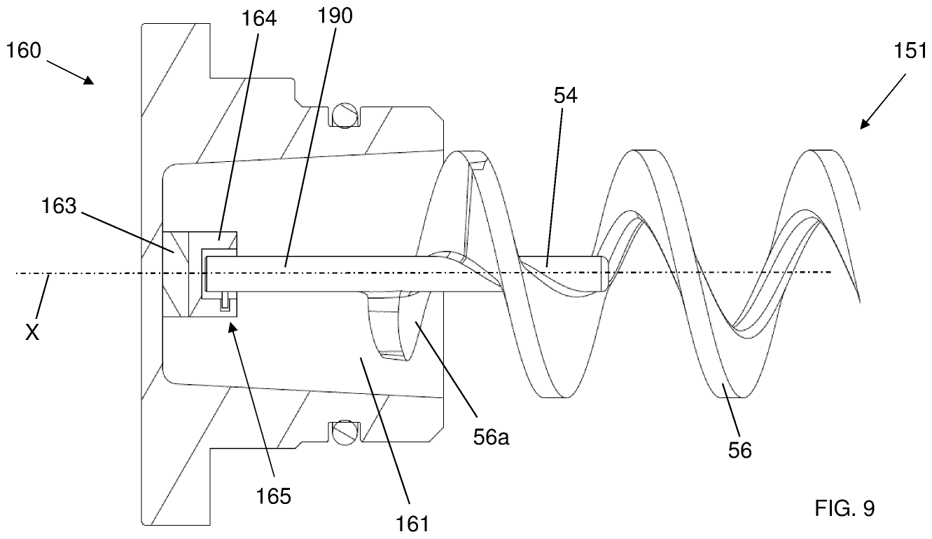

In a further preferred embodiment (not shown), the cabinet may comprise an openable door associated to the aperture 7 to give access thereto, and so that the microparticles filter device is preferably completely placed inside the cabinet. FIGS. 8 and 9 show a further preferred embodiment of the invention which differs from the preferred embodiment previously described in that the rotatable element 151 forming part of the cleaning device 150, still embodied as a worm comprising a helix-shaped element 56, and the collecting chamber 160 of the microparticles filter device 130 are removably connected one another, so that, while the collecting chamber 160 is removed from the filtering chamber 36, the rotatable element 151 preferably remains connected to the collecting chamber 160 and afterwards the collecting chamber 160 may be removed from the rotatable element 151.

In the drawings, corresponding characteristics and/or components of the first embodiment previously described are identified by the same reference numbers. According to this preferred embodiment, the elongated pin 190 of the rotatable element 151 and the collecting chamber 160 are preferably removably connected one another.

As illustrated in FIG. 9, the elongated pin 190 is removably connected to a first connecting element 164 through a removable locking device 165.

The releasable locking device 165 preferably comprise a releasable bayonet-like locking system.

The first connecting element 164 is rotatable mounted on a second connecting element 163 that is fixedly mounted on the collecting chamber 160. The second connecting element 163 is provided in the storage area 161 of the collecting chamber 160.

When the rotatable element 151 rotates, the elongated pin 190 and the first connecting element 164 rotate together with respect to the second connecting element 163 and the collecting chamber 160.

When the collecting chamber 160 is removed (for example unscrewed) from the housing body 32, the collecting chamber 160 remains engaged with the elongated pin 190. While the collecting chamber 160 is removed (for example unscrewed) from the housing body 32, the elongated pin 190 remains engaged with the collecting chamber 160 and therefore said elongated pin 190 provides an extraction aid member 190 to remove the rotatable element 151 from the housing body 32 and from the filtering chamber 36.

In the operating position illustrated in FIG. 8, which refers to a maintenance phase of the laundry washing machine 1, the collecting chamber 160 and the rotatable element 151 are fully extracted out of the housing body 32 so that the microparticles filter element 40 and its filtering surface 42 are advantageously accessible from outside. A user may reach the microparticles filter element 40 and its filtering surface 42 for a proper cleaning process that might be due after a relatively long operation time of the rotatable element 151 wiping a side of the filtering surface 42. More preferably, as described above, the microparticles filter element 40 is removably arranged in the filtering chamber 36 so that the user may extract the microparticles filter element 40 from the filtering chamber 36 and hence facilitating the cleaning process and/or substitution of the same in case the microparticles filter element 40 is worn out or damaged.

Furthermore, once the collecting chamber 160 has been removed (for example unscrewed) from the filtering chamber 36, the collecting chamber 160 may be removed from the elongated pin 190, and hence from the rotatable element 151, by removing the elongated pin 190 from the first element 164 through the releasable locking device 165.

The collecting chamber 160 can hence be cleaned from microparticles stored in the storage area 161.

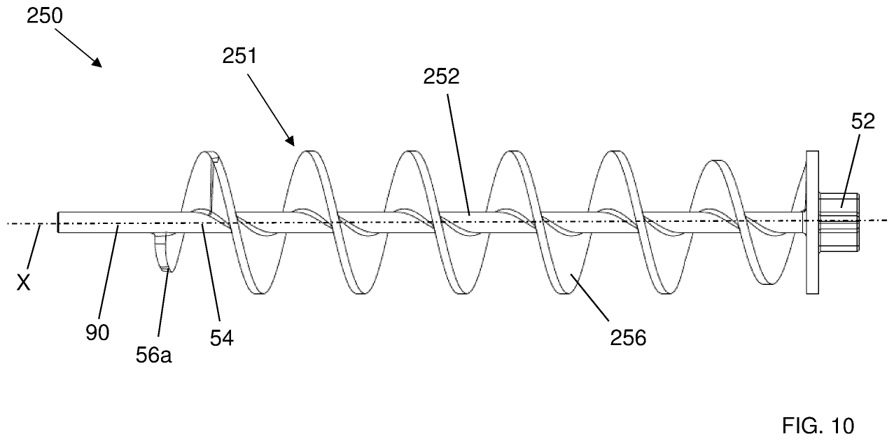

FIG. 10 shows an alternative preferred embodiment of the rotatable element 251 of the invention, forming part of the cleaning device 250, which differs from the preferred embodiment previously described in that the rotatable element 251 is not a hollow worm.

The rotatable element 251 comprises a central shaft body 252 extending along the main axis X between the end shaft bodies 52, 54 and a helix-shaped element 256 that winds around the central shaft body 252, preferably integrally made with the central shaft body 252. The helix-shaped element 256 is preferably a circular helix-shaped element 256. According to this embodiment, the helix-shaped element 256 substantially defines a helicoid.

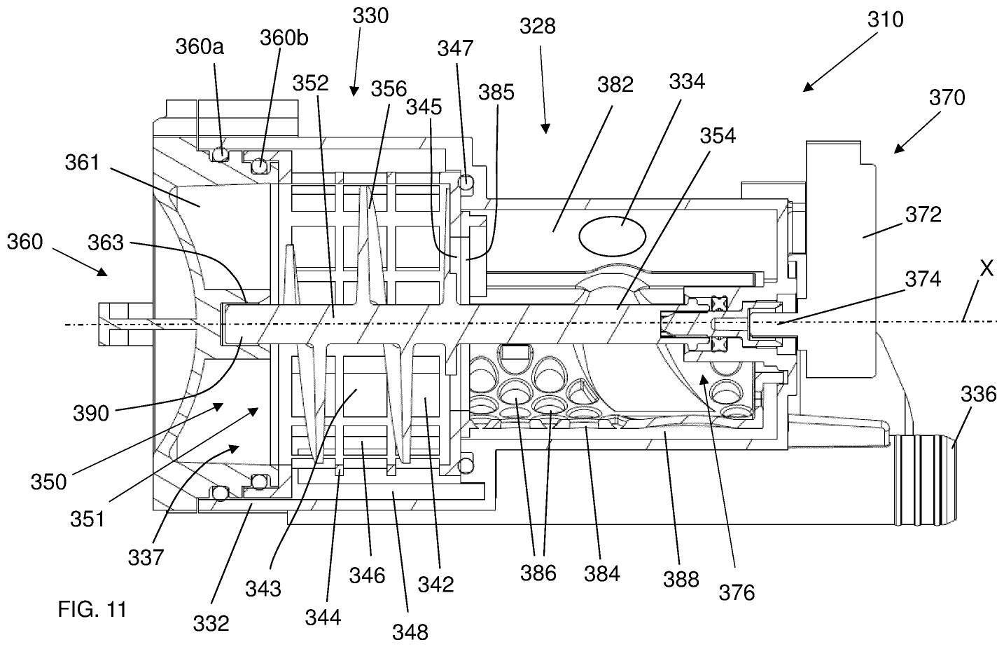

FIG. 11 shows a further preferred embodiment of the microparticles filter device 330.

According to this further preferred embodiment of the invention, the objects filter device 328 retaining coarse material, corresponding to the objects filter device 28 previously described, and the microparticles filter device 330 are integrated to define a filtering group assembly 310.

Preferably, the filtering group assembly 310 according to the invention is arranged in the draining system 20 of the laundry washing machine 1. More preferably, the filtering group assembly 310 is arranged between the main discharging pipe 22 and the draining pump 24.

The filtering group assembly 310 is preferably arranged in the lower part of the laundry washing machine 1, more preferably in the lower right side of the laundry washing machine 1. The filtering group assembly 310 is preferably placed just below the sump 15 and connected thereto by means of said main discharging pipe 22.

The microparticles filter device 330 and the objects filter device 328 preferably extend next to each other within the same body element.

The filtering group assembly 310 preferably shows an elongated shape and preferably extends along a main axis X.

The filtering group assembly 310 comprises a housing body 332, preferably made of a plastic, i.e. polymeric, material.

The filtering group assembly 310 comprises an inlet 334 that is connected to the main discharging pipe 22 and that allows the liquid entering the filtering group assembly 310, preferably entering the objects filter device 328.

The filtering group assembly 310 then comprises a main outlet 336, for filtered liquid, that is connected to the draining pump 24.

As said above, the filtering group assembly 310 comprises a microparticles filter device 330 for retaining microparticles.

The microparticles filter device 330 comprises a first filtering chamber 342 that receives therein a microparticles filter element 344 having a filtering surface 346 at which microparticles accumulate while the liquid flows therethrough. An amount of the volume encased by the housing body 332 defines the first filtering chamber 342.

The first filtering chamber 342 is thus housed in the housing body 332.

The first filtering chamber 342 is preferably cylindrically shaped and the microparticles filter element 344 preferably has a cylindrical tubular shape. The first filtering chamber 342 and the microparticles filter element 344 preferably extends along said main axis X. The filtering surface 46 preferably comprises a plurality of meshes, more preferably rectangular meshes.

The microparticles filter element 344 preferably defines an unfiltered volume 343 apt to receive the liquid before its microfiltration. The unfiltered volume 343 corresponds to the inner cylindrical volume of the microparticles filter element 344. The liquid is supplied into the unfiltered volume 43 and then undergoes to filtration by passing through the microparticles filter element 344, in particular by passing through meshes. The filtered liquid thus reaches an elongated annular chamber 348 that is radially outer the microparticles filter element 344 and that forms part of the first filtering chamber 342. The elongated annular chamber 348 hydraulically communicates with the main outlet 336 of the filtering group assembly 310. Hence, the main outlet 336 and the first filtering chamber 342 hydraulically communicates one to the other.

While the liquid flows through the microparticles filter element 344, microparticles progressively accumulate on the filtering surface 346.

The extension of the first filtering chamber 342 along the main axis X substantially corresponds to the filtering area defined by the microparticles filter element 344 and, more preferably, defined by said meshes.

Nevertheless, the first filtering chamber 342 may comprise portions that extends outside said filtering area and that are preferably used to assemble the microparticles filter element, for example for receiving sealing elements or for the connection of the microparticles filter element to other parts of the filtering group assembly 310.

As said above, the filtering group assembly 310 also comprises an objects filter device 328 for retaining coarse material. The objects filter device 328 is preferably arranged next to the microparticles filter device 330, within the same housing body 332.

The objects filter device 328 is arranged upstream the microparticles filter device 330.

The term “upstream” here refers to the flowing direction of the liquid to be filtered that enters the filtering group assembly 310 through the inlet and that reaches the main outlet 336 during the functioning of the washing machine; saying that objects filter device 328 is arranged upstream the microparticles filter device 330 means that during functioning of the draining pump 24 the liquid firstly passes through the objects filter device 328 and then flows into the microparticles filter device 330.

The objects filter device 328 is thus located between the inlet for liquid to be filtered and the microparticles filter device 330.

The objects filter device 328 comprises a second filtering chamber 382 that receives therein an objects filter element 384 configured to retain coarse element when liquid flows therethrough.

An amount of the volume encased by the housing body 332 defines the second filtering chamber 382.

The second filtering chamber 382 is thus housed in the housing body 332.

The first filtering chamber 342 and the second filtering chamber 382 are, therefore, housed within the same body element 332.

In the preferred embodiment illustrated herein, the objects filter element 384 is embodied as a hollow half-cylinder provided with apertures 386 having proper size to retain objects having a maximum dimension higher than 5 mm, for example 5 mm diameter circular apertures.

In further preferred embodiments, the objects filter element may be configured differently. For example, the objects filter element may be embodied as a channel through which liquid to be filtered flows and it can be provided with a meandering structure, for example in the form of tabs that are arranged along the channel so as to create a labyrinthic path through which the liquid flows while objects are stopped by the tabs.

The second filtering chamber 382 is preferably cylindrically shaped and the objects filter element 384 preferably has a shape that matches said cylindrical shape, for example half-cylindrically shaped.

The second filtering chamber 382 and the objects filter element 384 preferably extends along the main axis X.

The objects filter element 384 is preferably arranged in the lower/bottom part of the second filtering chamber 382 when the laundry washing machine 1 is in its standing working position.

The objects filter element 384 receives liquid from above, coming from the inlet 334, and then liquid undergoes to filtration by passing through the objects filter element 384 with its apertures 386. The filtered liquid thus reaches an elongated semi-annular chamber 388 that is radially outer the objects filter element 384 and that forms part of the second filtering chamber 382. The liquid from the elongated semi-annular chamber 388 reaches the first filtering chamber 342, as described below.

Advantageously, the radial thickness of the semi-annular chamber 388, which is defined by the shorter distance between the second filtering chamber 382 and the objects filter element 384, is dimensioned such that, even in case an object having a predominant extension along a single direction, like a needle for example, can pass through the apertures 386, it will remain entrapped by the semi-annular chamber 388 because its longer dimension will not allow a sufficient movement to pass through said apertures 386 and leaving the second filtering chamber 382. In that way, the semi-annular chamber 388 contribute to create a meandering structure for stopping objects having a maximum dimension higher than 5 mm.

The objects filter device 328 thus retain undesirable objects that may damage the draining pump 24, for example may damage the impeller in case a centrifugal pump design is used.

The objects filter element 384 of the objects filter device 328 is preferably arranged next to the microparticles filter element 344 of the microparticles filter device 330 in the same housing body 332. More preferably, the objects filter element 384 of the objects filter device 328 is in contact with the microparticles filter element 344 of the microparticles filter device 330.

The objects filter element 384 of the objects filter device 328 and the microparticles filter element 344 of the microparticles filter device 330 preferably communicates through respective apertures 345, 385 facing one the other.

Liquid may hence flow from the second filtering chamber 382 to the first filtering chamber 342 by passing through said apertures 345, 385.

When the draining system 20 operates, with activation of the draining pump 24, liquid enters the second filtering chamber 382 through the inlet 334, undergoes to filtration action of the objects filter element 384, reaches the elongated semi-annular chamber 388, passes through said apertures 345, 345, enters the first filtering chamber 342, undergoes to filtration action of the microparticles filter element 344, exits the filtering group assembly 310 through the main outlet 336 and is then drained to the outside through the outlet pipe 26.

Liquid flowing through the filtering group assembly 310 and discharged to the outside of the laundry washing machine 1 is thus subjected to the action of both the objects filter device 328 and the microparticles filter device 330.

The filtering group assembly 310 is equipped with a cleaning device 350 which is configured to remove microparticles that accumulate on the first side of the filtering surface 346 of the microparticles filtering element 344 that the liquid encounters when passing through said filtering surface 346.

The cleaning device 350 is preferably arranged inside the microparticles filter element 344 for moving microparticles it removes from the filtering surface 346 towards a storage volume 361 of a collecting chamber 360. The collecting chamber 360 is arranged at a side, in particular an end side, of the first filtering chamber 342 and in communication therewith. Microparticles removed from the filtering surface 346 are conveyed towards the storage volume 361 of the collecting chamber 360 and towards an opening 337 provided in the housing body 332, such that microparticles can be removed from the filtering group assembly 310 by removing the collecting chamber 360 therefrom.

According to the preferred embodiment described herein, the movable cleaning device 350 comprises a rotatable element 351 wiping a side of the filtering surface 346, preferably wiping the first side of the filtering surface 346 that the liquid encounters and where microparticles accumulates. More preferably, the rotatable element 351 may be embodied as a worm having a central shaft body 352 extending along a main axis X and a helix-shaped element 356 that winds around the central shaft body 352, preferably integrally made with the central shaft body 352.

This main axis X corresponds to the direction through which the rotatable element 351 extends. In the preferred embodiment described herein, this main axis X preferably coincides with the main axis X of the filtering group assembly 310.

The helix-shaped element 356 is preferably a circular helix-shaped element 356. According to this embodiment, the helix-shaped element 356 substantially defines a helicoid.

In the embodiment described above, the rotatable element 351 is rotated around the main axis X, the helix-shaped element 356 wipes a side of the filtering surface 346 of the microparticles filter element 344 thereby removing microparticles accumulated thereon, and, at the same time, it is able to move microparticles towards the storage volume 361 of the collecting chamber 360, eventually acting as a worm conveyor.

Microparticles are therefore collected into the storage volume 361 of the collecting chamber 360 as the rotatable element 351 rotates.

Advantageously, microparticles moved towards the collecting chamber 360 are pressed in the storage volume 361 by the action of helix-shaped element 356. The objects filter device 328 is provided in a position opposite to the collecting chamber 360 and the second filtering chamber 382 of the objects filter device 328 receives a portion 354 of the cleaning device 350 therein. Preferably, the second filtering chamber 382 of the objects filter device 328 receives a portion 354 of the central shaft body 352 of the cleaning device 350.

Rotation of the rotatable element 351 is preferably obtained through an actuating device 370.

The actuating device 370 is preferably arranged at a first end of the central shaft body 352 of the rotatable element 351, preferably at a first end of the portion 354 of the central shaft 352 received in the second filter chamber 382. The actuating device 370 preferably comprises an electric motor 372 having a rotatable shaft 374 cooperating with the central shaft body 352 of the rotatable element 351.

An interconnection device 376 is preferably arranged between the central shaft body 352 of the rotatable element 351 and the rotatable shaft 374 of the electric motor 372. The interconnection device 376, not described in detail, allows transmission of rotation of the rotatable shaft 374 to the rotatable element 351 and also allows disconnection of the rotatable element 351 from the rotatable shaft 374 so that the rotatable element 351 may be removed from the first housing body 332.

The collecting chamber 360 is configured to be removably coupled with respect to the housing body 332. The collecting chamber 360 works as a cap for the opening 337, closing the latter when it is coupled to the housing body 332.

The collecting chamber 360 is preferably removably coupled to the housing body 332 by a mechanical interference and hence the collecting chamber 360 is preferably removably coupled to the housing body 332 by a pushing/pulling action. In further preferred embodiments, the collecting chamber may be configured to be removably coupled to the housing body by a snap-in action or configured to be screwable to the housing body.

Between the collecting chamber 360 and the housing body 332, sealing elements 360a, for example plastic, i.e. polymeric, O-rings, are preferably arranged to guarantee watertightness during the filtering process and also crating mechanical interference.

Between the collecting chamber 360 and the microparticles filter element 344, sealing elements 360b, for example plastic, i.e. polymeric, O-rings, are also preferably arranged to further guarantee watertightness during the filtering process and also crating mechanical interference.

According to the invention, the cleaning device 350 comprises a portion 390 extending into the storage volume 361 of the collecting chamber 360 thereby providing an extraction aid member 390 to remove the cleaning device 350 from the housing body 332 when the collecting chamber 360 is removed from the housing body 332.

The portion 390 of the cleaning device 350 extending into the storage volume 361 of the collecting chamber 360 is preferably embodied as a portion 390 that protrudes from the first filtering chamber 342 and extends into the storage volume 361 of the collecting chamber 360. In this embodiment the volume occupied by the cleaning device portion extending inside the storage volume 361 of the collecting chamber 360 is about 2% of the storage volume 361 where microparticles are accumulated.

Preferably, the portion 390 is embodied as an extension of the central shaft body 352 of the rotatable element 351.

The portion 390 and the collecting chamber 360 are preferably removably coupled one another. The portion 390 is preferably received in a supporting seat 363 realized in the storage volume 361 of the collecting chamber 360.

When the rotatable element 351 rotates, the portion 390 rotates within the supporting seat 363. The supporting seat 363 preferably acts as a centering means while the rotatable element 351 works/rotates.

The supporting seat 363 and the portion 390 are shaped, for example both cylindrically shaped, so that the portion 390 may rotate with respect to the supporting seat 363 when the rotatable element 351 rotates while the collecting chamber 360 may be disengaged from the portion 390 when the collecting chamber 360 is removed from the housing body 332.

The cleaning device 350 and the collecting chamber 360 are therefore preferably removably coupled one another so that the collecting chamber 360 can be disconnected from the cleaning device 350 when the collecting chamber 360 is removed from the housing body 332.

When the collecting chamber 360 is removed from the housing body 332, the portion 390 provides an extraction aid member 390 to remove the rotatable element 351 from the housing body 332. The rotatable element 351 is hence also advantageously removable from the first and second filtering chambers 342, 382 of the respective filter devices 330, 328. In particular, the rotatable element 351 can be removed from the first and second filtering chambers 342, 382 by extracting the rotatable element 351 through the opening 337 of the housing body 332.

The portion 390, in fact, can be usefully grasped by a user and pulled along the main axis X so that the rotatable element 351 disconnects from the motor 72 and can be fully extracted out of the housing body 332.

After the rotatable element 351 is fully extracted out of the housing body 332, the microparticles filter element 344 and its filtering surface 346 and the objects filter element 384 of the objects filter device 328 are advantageously accessible from outside. A user may reach the microparticles filter element 344 and its filtering surface 346 and/or the objects filter element 384 of the objects filter device 328 for a proper cleaning process.

More preferably, the microparticles filter element 344 is removably arranged in the first filtering chamber 342 of the microparticles filter device 330. Advantageously, after removal of the collecting chamber 360 the user may also extract the microparticles filter element 344 from the first filtering chamber 342 and hence facilitating the cleaning process and/or substitution of the same in case the microparticles filter element 344 is worn out or damaged. In particular, the microparticles filter element 344 can be extracted from the first filtering chamber 342 through the opening 337 of the housing body 332.

More preferably, the objects filter element 384 is removably arranged in the second filtering chamber 382 of the objects filter device 328. Advantageously, after removal of the collecting chamber 360 and removal of the microparticles filter element 344 of microparticles filter device 330 the user may also extract the objects filter element 384 from the second filtering chamber 382 of the objects filter device 328 and hence facilitating the cleaning process and/or substitution of the same in case the objects filter element 384 is damaged. In particular, the objects filter device 328 can be extracted from the second filtering chamber 382 through the opening 337 of the housing body 332.

Between the microparticles filter element 344 of the microparticles filter device 330 and the housing body 332, a sealing element 347, for example plastic, i.e. polymeric, O-ring, is preferably arranged to guarantee watertightness of the first filtering chamber 342 during the filtering process.

The microparticles filter element 344 preferably extends towards the frontal part of the housing body 332 of the microparticles filter device 330 and preferably receives a portion of the collecting chamber 360 therein.

This facilitates extraction of the microparticles filter element 344 which may be grasped by the user after removal of the collecting chamber 360.

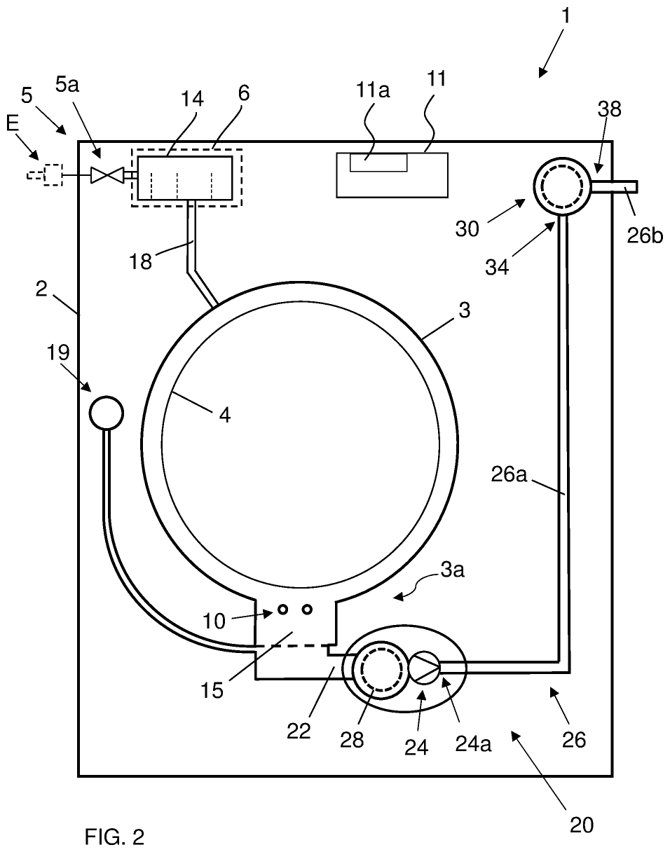

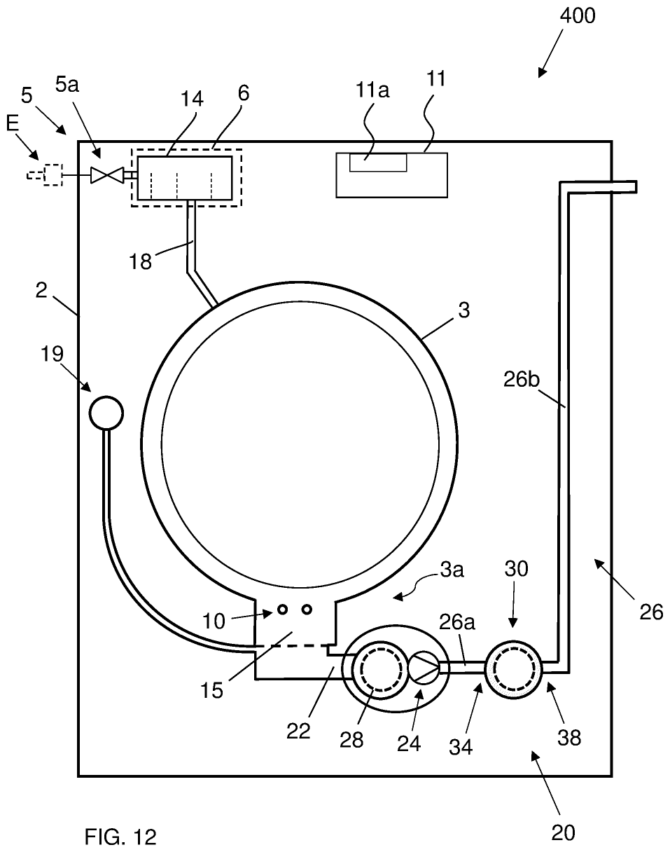

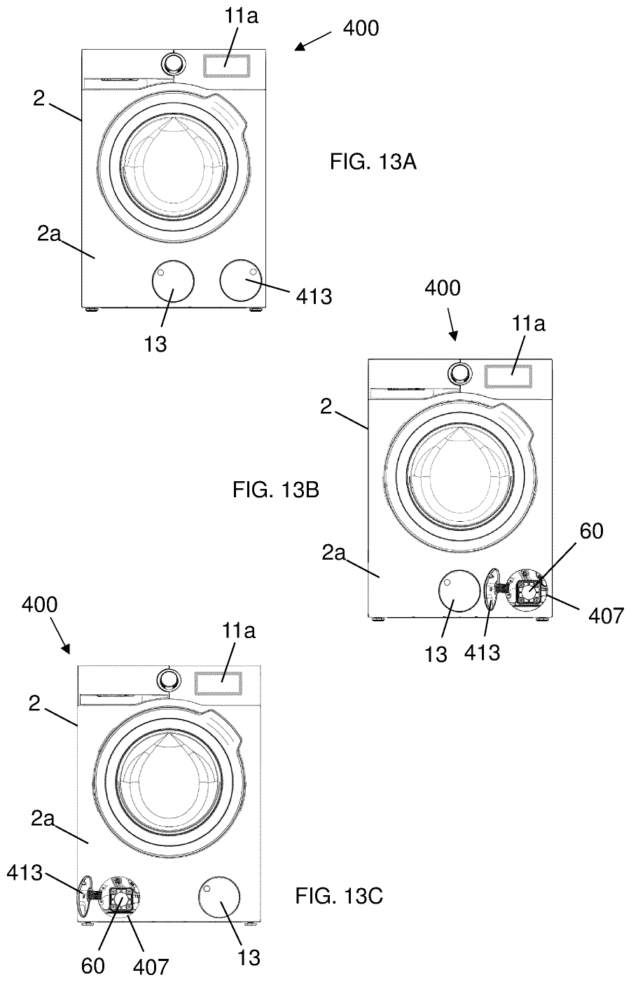

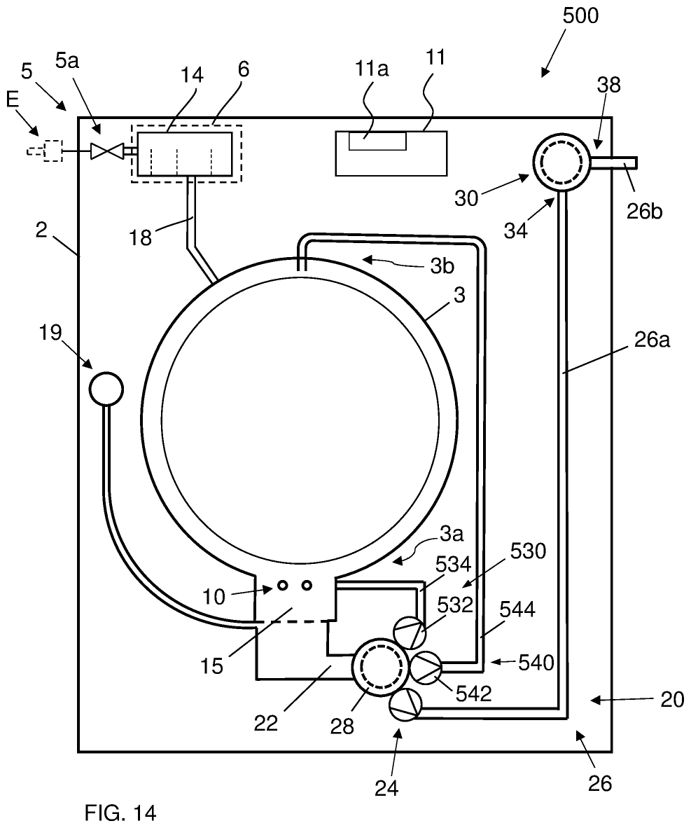

FIG. 12 shows a schematic view of a further preferred embodiment of a laundry washing machine 400 according to the invention. FIGS. 13A and 13B show the frontal view of the laundry washing machine 400. In the drawings, corresponding characteristics and/or components of the embodiment described in FIGS. 1 and 2 are identified by the same reference numbers.

This further preferred embodiment of the invention differs from the preferred embodiment previously described with reference to FIGS. 1 to 7 in that the microparticles filter device 30 is arranged in the draining system 20 in the lower part of the laundry washing machine 400.

The microparticles filter device 30 is preferably horizontally aligned to the draining pump 24, i.e. the microparticles filter device 30 can be placed substantially at the same height of the draining pump 24 relative to a surface on which the entire laundry washing machine 400 stands.

The cabinet 2 preferably comprises an aperture 407 so that the collecting chamber 60 of the microparticles filter device 30 is accessible from outside to a user, as illustrated in FIG. 13B. The cabinet 2 preferably comprises an openable door 413 associated to the aperture 407 to give access thereto.

The aperture 407 and the respective openable door 413 are preferably placed on the front side wall 2a of the cabinet 2.

According to the embodiment shown in FIGS. 12, 13A, 13B the microparticles filter device 30 is arranged in the draining system 20 in the lower, preferably right, side of the laundry washing machine 400, further preferably, close to the objects filter device 28.

The aperture 407 and the respective door 413 are preferably aligned with the microparticles filter device 30 and hence arranged in the lower, preferably right, side of the laundry washing machine 400, more preferably close to the openable gate 13 for the objects filter device 28.

In different embodiments, nevertheless, the objects filter device 28, the microparticles filter device 30 and respective doors 13, 413 may be differently arranged in the lower part of the laundry washing machine 400, for example as illustrated in FIG. 13C wherein the objects filter device 28 and the microparticles filter device 30 are arranged on opposite regions of the laundry washing machine 400 separated by a vertical middle plane diving in two equal parts the front side wall 2a of the cabinet 2.

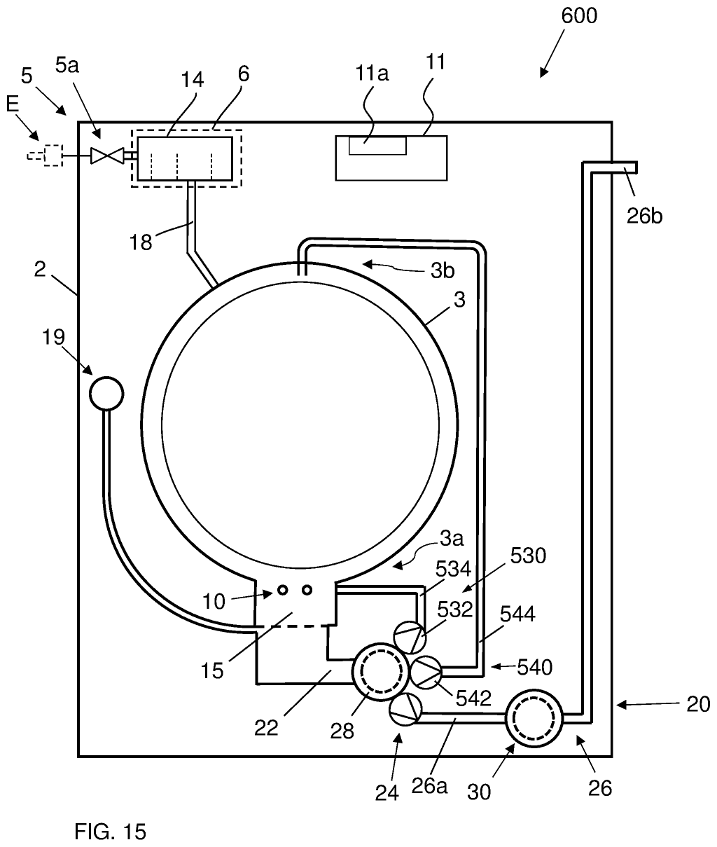

FIG. 14 shows a schematic view of a further preferred embodiment of a laundry washing machine 500 according to the invention. In the drawing, corresponding characteristics and/or components of the embodiment described in FIG. 2 are identified by the same reference numbers.

This preferred embodiment of the invention differs from the preferred embodiment previously described with reference to FIG. 2 in that the laundry washing machine 500 preferably comprises a first recirculation system 530 which is adapted to drain liquid from a bottom region 3a, placed at a bottom part of the washing tub 3, and to re-admit such a liquid back again into said bottom region 3a of the washing tub 3 and a second recirculation system 540 which is adapted to drain liquid from said bottom region 3a of the washing tub 3 and to re-admit such a liquid into a second region 3b of the washing tub 3, placed at a higher level relative to the bottom region 3a.

The liquid taken from the washing tub 3 is preferably re-admitted to the bottom region 3a of the washing tub 3 for mixing and/or dissolving laundry treating products, in particular detergent in powder or liquid form. Mixing and/or dissolving of a laundry treating product is preferably carried out during a washing cycle when one of the products is supplied into the washing tub 3 from the treating agents dispenser 14.

Preferably, the second region 3b of the washing tub 3 substantially corresponds to an upper region 3b of the washing tub 3. The liquid is preferably re-admitted to the upper region 3b of the washing tub 3 to improve wetting of the laundry inside the washing drum 4. This action is preferably carried out at the beginning of a washing cycle when the laundry needs to be completely soaked. Furthermore, this action is preferably carried out during rinsing phases at the beginning of the washing cycle or during rinsing phases in successive steps of the washing cycle. Furthermore, this action can be also carried out during a main wash phase so as to efficiently reach laundry that rest in an upper region of the drum.

The first recirculation system 530 preferably comprises a first recirculation pump 532 connected downstream the objects filter device 28 and a first recirculation line 534 for conveying liquid to the bottom region 3a of the washing tub 3.

The second recirculation system 540 preferably comprises a second recirculation pump 542 connected downstream the objects filter device 28 and a second recirculation line 544 for conveying liquid to the second region 3b of the washing tub 3.

FIG. 15 shows a schematic view of a further preferred embodiment of a laundry washing machine 600 according to the invention. In the drawing, corresponding characteristics and/or components of the embodiment described in FIG. 14 are identified by the same reference numbers.

This preferred embodiment of the invention differs from the preferred embodiment previously described with reference to FIG. 14 in that the microparticles filter device 30 is arranged in the draining system 20 in the lower part of the laundry washing machine 600, more preferably in the lower right side of the laundry washing machine 600.

In the preferred embodiments described above, the cleaning device preferably comprises a rotatable element, in particular a worm, provided with a portion that acts as an extraction aid member.

In further preferred embodiments, the cleaning device may preferably comprise a translatable element wiping a side of the filtering surface of the microparticles filter member.

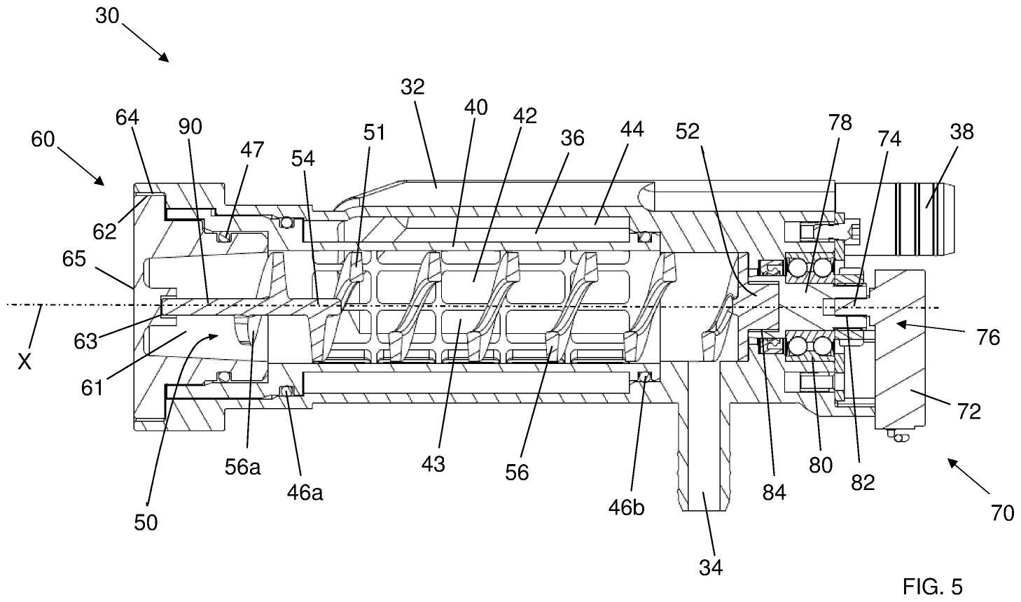

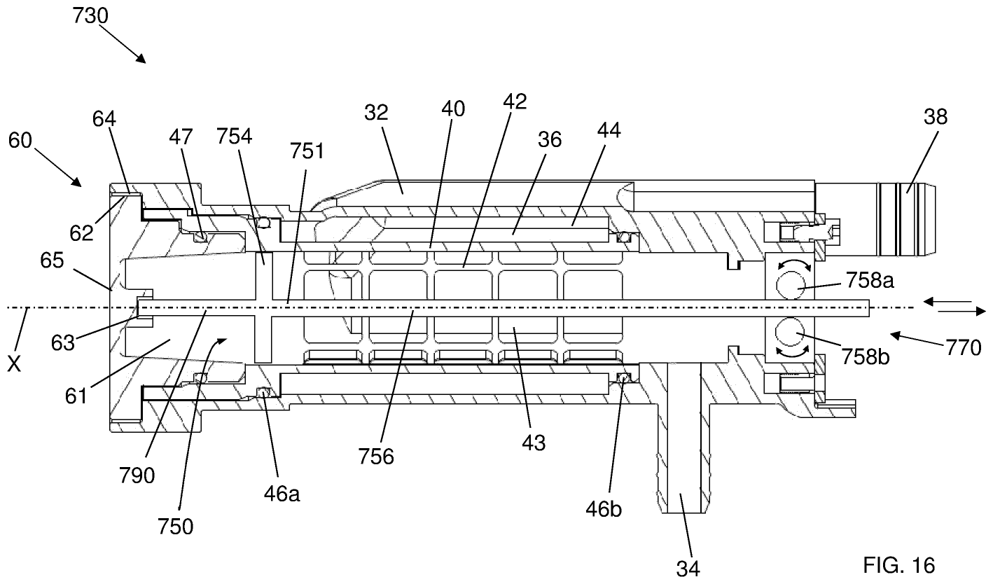

FIG. 16 exemplary shows a solution of this type. In the drawing, corresponding characteristics and/or components of the embodiment described in FIG. 5 are identified by the same reference numbers.

In the microparticles filter device 730 according to this embodiment, the cleaning device 750 comprises a translatable element 751.

The translatable element 751 preferably comprises a piston with a reciprocating rectilinear motion along the main axis direction X.

The piston 751 preferably comprises a head portion 754 and a main shaft 756. External surfaces of the head portion 754 wipes a side of the filtering surface 42 of the microparticles filter element 40. Microparticles removed from the filtering surface 42 are moved towards the collecting chamber 60 by the translation movement of the piston 751.

The reciprocating rectilinear motion of the piston 751 is preferably obtained through an actuating device 770.

The actuating device 770 preferably cooperates with the main shaft 756 of the piston 751 and preferably comprises two wheels 758b, 758b engaging the main shaft 756 and opportunely rotate to move back and forth the piston 751.

The translatable element 751, according to the invention, is further provided with a portion 790 that acts as an extraction aid member 790, as explained above.

In the preferred embodiments described above, the microparticles filter device is preferably arranged within the cabinet of the laundry washing machine.

In further preferred embodiments, the microparticles filter device may be mounted to an outer side of a cabinet wall and may be fluidly connected to the laundry washing machine draining system. In this way, a user can easily handle the microparticles filter device when it is needed to remove microparticles accumulated therein. In addition, by providing a microparticles filter device mounted to a side of a cabinet wall, i.e. outside of the inner volume defined by the laundry washing machine cabinet walls, it is possible to enlarge the microparticles storage capacity of the filter device, so as to prolong the operation of the filter device before a microparticles removal intervention is required.

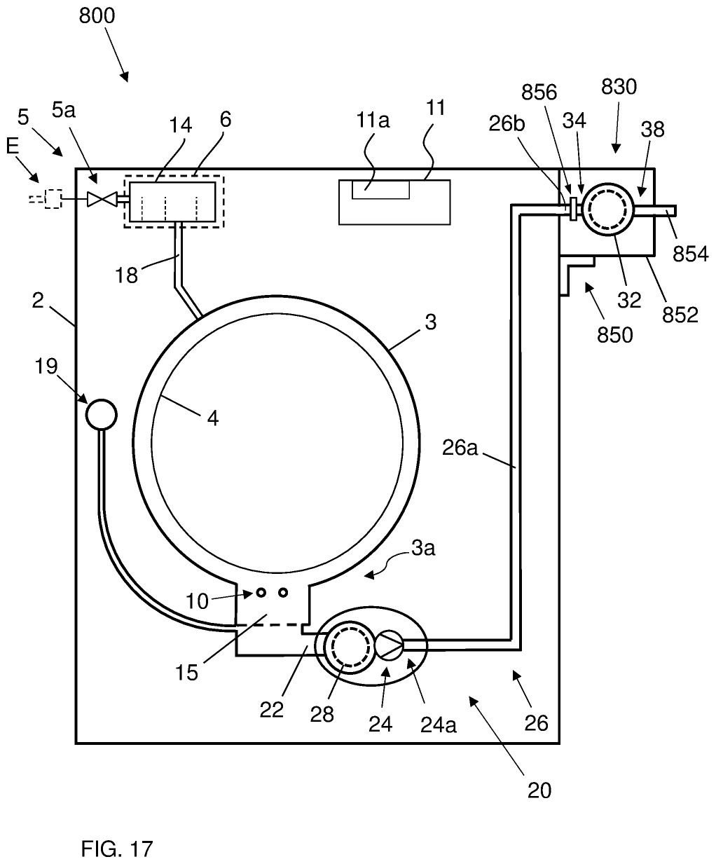

FIG. 17 exemplary shows a solution of this type. In the drawing, corresponding characteristics and/or components of the first embodiment described above, in particular with reference to FIG. 5, are identified by the same reference numbers. According to this embodiment, a microparticles filter device 830 is embodied as a unit provided to the laundry washing machine 800 by being mounted to an outer side of a wall of the outer cabinet 2. The microparticles filter device 830 is preferably mounted to the outer cabinet 2 of the laundry washing machine 800 through a connecting device 850, for example an L-shaped bracket or a hooking device. The microparticles filter device 830 preferably, though not necessarily, comprises an external housing 852 and the latest is preferably connectable/connected to the outer cabinet 2 of the laundry washing machine 800 through said connecting device 850. In another embodiment, the housing body 32 of the microparticles filter device 830 can be provided with connecting members, such as eyelets, allowing the housing body 32 to be mounted to the outer cabinet 2 of the laundry washing machine 800.

The microparticles filter device 830 may be realized according to preferred embodiments as described above, for example the microparticles filter device 30, 130, 730 shown and described above.

According to this embodiment, the inlet 34 of the microparticles filter device 830 is preferably connected to the second portion 26b of the outlet pipe 26 protruding out of the cabinet 2, preferably through a proper hydraulic connector 856.

The outlet 38 of the microparticles filter device 830 is provided for being hydraulically connected to a drainage outside the machine 800, preferably through an outlet pipe 854.

Before the liquid reaches the drainage outside the machine 800, liquid is therefore subjected to a filtration process by means of the microparticles filter device 830, preventing microparticles leaving the laundry washing machine 800.

In a preferred embodiment, the external housing 852 preferably comprises an aperture (not shown) so that the collecting chamber of the microparticles filter device 830 is accessible to a user, from outside the external housing 852. The collecting chamber is preferably arranged to close the aperture of the external housing 832 so that said collecting chamber is directly accessible to the user from a part of the external housing 852 remaining exposed to a user interaction.

More preferably, the microparticles filter device 830 is arranged with respect to said aperture of the external housing 832 so that the exposed surface 65 of the collecting chamber 60 fits preferably flush with a side wall of the external housing 852.

The majority of the microparticles filter device 830 is thus preferably arranged inside the external housing 852. In a further preferred embodiment, the external housing 852 may comprise an openable door associated to the aperture to give access thereto, and so that the microparticles filter device is preferably completely placed inside the external housing 852.

According to this embodiment, advantageously, an existing laundry washing machine may be equipped with a microparticles filter device according to the invention preventing microparticles leaving the laundry washing machine.

It has thus been shown that the present invention allows all the set objects to be achieved. In particular, the invention makes possible to provide a laundry washing machine that allows maintenance of a microparticles filtering element, such as cleaning or replacing operations of the filtering element, with respect to the known laundry washing machines.

While the present invention has been described with reference to particular embodiments shown in the figures, it should be noted that the present invention is not limited to the specific embodiments illustrated and described herein; on the contrary, further variants of the embodiments described herein fall within the scope of the present invention, which is defined in the appended claims.

1. A laundry washing machine (1) comprising:
an outer cabinet (2);
a washing tub (3) containing a washing drum (4) suited to receive the laundry to be washed;
a liquid supply system (5) suitable to convey a liquid to said washing tub (3);
a draining system (20) suitable to drain liquid outside said outer cabinet (2);
a microparticles filter device (30) comprising:
a housing body (32);
an inlet (34) for liquid to be filtered;
a filtering chamber (36) housed in said housing body (32), said filtering chamber (36) comprising a microparticles filter element (40) having a filtering surface (42) on which microparticles accumulate while said liquid flows therethrough;
an outlet (38) for filtered liquid;
a cleaning device (50) movably arranged in said filtering chamber (36) for removing microparticles that accumulate on said filtering surface (42), said cleaning device (50) moving microparticles removed from said filtering surface (42) towards a storage volume (61) of a collecting chamber (60) arranged at a side of said filtering chamber (36) and in communication therewith;
characterized in that said collecting chamber (60) is configured to be removably coupled with respect to said housing body (32) and in that said cleaning device (50) comprises at least a portion (90) extending into said storage volume (61) of said collecting chamber (60) thereby providing an extraction aid member (90) to remove said cleaning device (50) from said housing body (32) when said collecting chamber (60) is removed from said housing body (32).

2. Washing machine (1) according to claim 1, characterized in that said microparticles filter element (40) is removably arranged in said filtering chamber (36).

3. Washing machine (1) according to any of the preceding claims, characterized in that said cleaning device (50) is configured to be removably coupled to said filtering chamber (36).

4. Washing machine (1) according to claim 3, characterized in that said cleaning device (50) comprises a rotatable element (51) apt to remove microparticles that accumulate on said filtering surface (42).

5. Washing machine (1) according to claim 4, characterized in that said rotatable element (51) comprises a worm comprising a first end shaft body (52), a second end shaft body (54) and a helix-shaped element (56) connecting said end shaft bodies (52, 54) and winding around a main axis (X).

6. Washing machine (1) according to claim 5, characterized in that said rotatable element (251) further comprises a central shaft body (252) extending along said main axis (X) between said first and second end shaft bodies (52, 54), said helix-shaped element (256) winding around said central shaft body.

7. Washing machine (1) according to claim 5 or 6, characterized in that said helix-shaped element (56, 256) at least partially extends into said collecting chamber (60).

8. Washing machine (1) according to any of the claims 1 to 3, characterized in that said cleaning device (750) comprises a translatable element (751) provided for wiping a side of said filtering surface (42).

9. Washing machine (1) according to any of the preceding claims, characterized in that it comprises an actuating device (70) for moving said cleaning device (50).

10. Washing machine (1) according to claim 9, characterized in that said actuating device (70) comprises an electric motor (72).

11. Washing machine (1) according to any of the preceding claims, characterized in that said cleaning device (50) and said collecting chamber (60) are removably coupled one another, so that when said collecting chamber (60) is removed from said housing body (32) said collecting chamber (60) is disconnected from said cleaning device (50).

12. Washing machine (1) according to any of the claims 1 to 10, characterized in that said cleaning device (150) and said collecting chamber (160) are removably connected one another by means of a releasable locking device (165), so that they can be disconnected one from the other by releasing said releasable locking device (165) after being unitarily removed from said housing body (32).

13. Washing machine (1) according to any of the preceding claims, characterized in that said collecting chamber (60) is screwable to said housing body (32).

14. Washing machine (1) according to any of the preceding claims, characterized in that said microparticles filter element (40) is a disposable filter element.

15. Washing machine (1) according to any of the preceding claims, characterized in that said microparticles filter device (30) is arranged in a flow path between said liquid supply system (5) and said draining system (20).

16. Washing machine (1) according to claim 15, characterized in that said microparticles filter device (30) is arranged in said draining system (20).

17. Washing machine (1) according to claim 16, characterized in that said draining system (20) comprises a draining pump (24) and an outlet pipe (26) ending outside said outer cabinet (2), said microparticles filter device (30) being arranged in a portion of said outlet pipe (26) contained within the volume defined by said outer cabinet (2).

18. Washing machine (1; 400) according to any of the preceding claims, characterized in that said outer cabinet (2) further comprises an aperture (7; 407) so that said collecting chamber (60) of said microparticles filter device (30) is accessible therefrom.

19. Washing machine (1; 400) according to claim 18, characterized in that said outer cabinet (2) further comprises an openable door (413) associated to said aperture (407).

20. Washing machine (1) according to claim 18 or 19, characterized in that said collecting chamber (60) is arranged to close said aperture (7) so that said collecting chamber (60) is directly accessible to a user.

21. Washing machine (800) according to any of the claims 1-14, characterized in that said microparticles filter device (830) is mounted to an outer side of a wall of said outer cabinet (2) and said inlet (34) of said microparticles filter device (830) is connected to said draining system (20) by means of an outlet pipe (26) ending outside said outer cabinet (2) of said laundry washing machine (800).

22. Washing machine (800) according to claim 21, characterized in that said microparticles filter device (830) is mounted to an outer side of a wall of said outer cabinet (2) by means of a connecting device (850).

23. Washing machine (1) according to any of the preceding claims, characterized in that said microparticles filter device (30) is a filter suitable to retain particles having a minimum dimension comprised between 0,1 μm and 5 mm, preferably a minimum dimension comprised between 10 μm and 100 μm, more preferably a minimum dimension comprised between 10 μm and 75 μm.

24. Washing machine (1) according to any of the preceding claims, characterized in that it further comprises an objects filter device (28; 328) arranged upstream said microparticles filter device (30; 330) for stopping objects having a maximum dimension higher than 5 mm contained in said liquid to be filtered when said liquid flows therethrough.

25. Washing machine (1) according to claim 24, characterized in that said objects filter device (328) is housed in said housing body (332), wherein said objects filter device (328) and said microparticles filter device (330) define a filtering group assembly (310), wherein said objects filter device (328) is provided in a position opposite to said collecting chamber (60) and located between an inlet (334) of said filtering group assembly (310) and said microparticles filter device (330), said objects filter device (328) comprising a second filtering chamber (382) receiving a portion (354) of said cleaning device (350) therein.

26. Washing machine (500) according to any of the preceding claims, characterized in that said liquid supply system (5) includes at least one recirculation system (530; 540) for draining liquid from a bottom region (3a) of said washing tub (3) to a second region (3b) of said washing tub (3).

27. A method for removing a cleaning device (50) of a microparticles filter device (30) in a laundry washing machine (1) realized according to any of the preceding claims, characterized in that it comprises the steps of:
removing said collecting chamber (60) from said housing body (32);
removing said cleaning device (50) from said housing body (32) by means of said extraction aid member (90).

28. A method according to claim 27, characterized in that said step of removing said cleaning device (50) from said housing body (32) by means of said extraction aid member (90) is performed after said step of removing said collecting chamber (60) from said housing body (32) wherein, after said collecting chamber (60) has been removed, said extraction aid member (90) is accessible to a user.

29. A method according to claim 27, characterized in that said step of removing said collecting chamber (160) from said housing body (32) and said step of removing said cleaning device (150) from said housing body (32) are performed simultaneously, wherein said collecting chamber (160) and said extraction aid member (190) remain engaged while said collecting chamber (160) is removed from said housing body (32).

30. A method according to claim 29, characterized in that it further comprises a step of disengaging said extraction aid member (190) from said collecting chamber (160) after said extraction aid member (190) and said collecting chamber (160) have been simultaneously removed from said housing body (32).
